(19) United States
(12) Patent Application Publication
(10) Pub. No.: US 2023/0217289 A1
(43) Pub. Date: Jul. 6, 2023

(54) LAYER 3 MEASUREMENT ASSOCIATED WITH DEDICATED POLARIZATION

(71) Applicant: QUALCOMM Incorporated, San Diego, CA (US)

(72) Inventors: Huilin XU, Temecula, CA (US); Lianghai JI, San Diego, CA (US); Liangping MA, San Diego, CA (US); Fei HUANG, San Diego, CA (US); Mehmet Izzet GURELLI, San Diego, CA (US); Weimin DUAN, San Diego, CA (US); Qiang WU, San Diego, CA (US); Jun MA, San Diego, CA (US); Karthik ANANTHA SWAMY, La Jolla, CA (US)

(21) Appl. No.: 17/647,159

(22) Filed: Jan. 5, 2022

(51) Int. Cl. H04W 24/10; H04W 28/02

(52) U.S. Cl. CPC H04W 24/10; H04W 28/0268

(57) ABSTRACT

Various aspects of the present disclosure generally relate to wireless communication. In some aspects, a user equipment (UE) may receive a measurement resource. The UE may perform a Layer 3 (L3) measurement of the measurement resource using a first polarization that is dedicated for performing L3 measurements and that is supported by the UE. Numerous other aspects are described.

### INTRODUCTION

Aspects of the present disclosure generally relate to wireless communication and to techniques and apparatuses for using a polarization for a measurement.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a measurement resource. The method may include performing a Layer 3 (L3) measurement of the measurement resource using a first polarization that is dedicated for performing L3 measurements and that is supported by the UE.

Some aspects described herein relate to a method of wireless communication performed by a UE. The method may include receiving a measurement resource. The method may include performing an L3 measurement of the measurement resource independent of a requirement for the UE to use a first polarization that is dedicated for performing L3 measurements, in response to the UE supporting use of the first polarization for L3 measurements. The method may include performing the L3 measurement of the measurement resource using a polarization of a most recent serving cell downlink communication in response to the UE not supporting use of the first polarization for L3 measurements.

Some aspects described herein relate to a method of wireless communication performed by a UE. The method may include receiving polarization information for measuring a measurement resource. The method may include receiving the measurement resource. The method may include performing an L3 measurement of the measurement resource based at least in part on the polarization information.

Some aspects described herein relate to a method of wireless communication performed by a UE. The method may include calculating a maximum quantity of measurement resources supported by the UE based at least in part on a configured timing for handling a mismatch between a polarization of a measurement resource and a polarization configured at the UE. The method may include receiving the measurement resource. The method may include performing an L3 measurement of the measurement resource based at least in part on the maximum quantity of measurement resources supported by the UE.

Some aspects described herein relate to a UE for wireless communication. The UE may include a memory and one or more processors coupled to the memory. The memory and the one or more processors may be configured to receive a measurement resource. The memory and the one or more processors may be configured to perform an L3 measurement of the measurement resource using a first polarization that is dedicated for performing L3 measurements and that is supported by the UE.

Some aspects described herein relate to a UE for wireless communication. The UE may include a memory and one or more processors coupled to the memory. The memory and the one or more processors may be configured to receive a measurement resource. The memory and the one or more processors may be configured to perform an L3 measurement of the measurement resource independent of a requirement for the UE to use a first polarization that is dedicated for performing L3 measurements, in response to the UE supporting use of the first polarization for L3 measurements. The memory and the one or more processors may be configured to perform the L3 measurement of the measurement resource using a polarization of a most recent serving cell downlink communication in response to the UE not supporting use of the first polarization for L3 measurements.

Some aspects described herein relate to a UE for wireless communication. The UE may include a memory and one or more processors coupled to the memory. The memory and the one or more processors may be configured to receive polarization information for measuring a measurement resource. The memory and the one or more processors may be configured to receive the measurement resource. The memory and the one or more processors may be configured to perform an L3 measurement of the measurement resource based at least in part on the polarization information.

Some aspects described herein relate to a UE for wireless communication. The UE may include a memory and one or more processors coupled to the memory. The memory and the one or more processors may be configured to calculate a maximum quantity of measurement resources supported by the UE based at least in part on a configured timing for handling a mismatch between a polarization of a measurement resource and a polarization configured at the UE. The memory and the one or more processors may be configured to receive the measurement resource. The memory and the one or more processors may be configured to perform an L3 measurement of the measurement resource based at least in part on the maximum quantity of measurement resources supported by the UE.

Some aspects described herein relate to a non-transitory computer-readable medium that stores a set of instructions for wireless communication by a UE. The set of instructions, when executed by one or more processors of the UE, may cause the UE to receive a measurement resource. The set of instructions, when executed by one or more processors of the UE, may cause the UE to perform an L3 measurement of the measurement resource using a first polarization that is dedicated for performing L3 measurements and that is supported by the UE.

Some aspects described herein relate to a non-transitory computer-readable medium that stores a set of instructions for wireless communication by a UE. The set of instructions, when executed by one or more processors of the UE, may cause the UE to receive a measurement resource. The set of instructions, when executed by one or more processors of the UE, may cause the UE to perform an L3 measurement of the measurement resource independent of a requirement for the UE to use a first polarization that is dedicated for performing L3 measurements, in response to the UE supporting use of the first polarization for L3 measurements. The set of instructions, when executed by one or more processors of the UE, may cause the UE to perform the L3 measurement of the measurement resource using a polarization of a most recent serving cell downlink communication in response to the UE not supporting use of the first polarization for L3 measurements.

Some aspects described herein relate to a non-transitory computer-readable medium that stores a set of instructions for wireless communication by a UE. The set of instructions, when executed by one or more processors of the UE, may cause the UE to receive polarization information for measuring a measurement resource. The set of instructions, when executed by one or more processors of the UE, may cause the UE to receive the measurement resource. The set of instructions, when executed by one or more processors of the UE, may cause the UE to perform an L3 measurement of the measurement resource based at least in part on the polarization information.

Some aspects described herein relate to a non-transitory computer-readable medium that stores a set of instructions for wireless communication by a UE. The set of instructions, when executed by one or more processors of the UE, may cause the UE to calculate a maximum quantity of measurement resources supported by the UE based at least in part on a configured timing for handling a mismatch between a polarization of a measurement resource and a polarization configured at the UE. The set of instructions, when executed by one or more processors of the UE, may cause the UE to receive the measurement resource. The set of instructions, when executed by one or more processors of the UE, may cause the UE to perform an L3 measurement of the measurement resource based at least in part on the maximum quantity of measurement resources supported by the UE.

Some aspects described herein relate to an apparatus for wireless communication. The apparatus may include means for receiving a measurement resource. The apparatus may include means for performing an L3 measurement of the measurement resource using a first polarization that is dedicated for performing L3 measurements and that is supported by the apparatus.

Some aspects described herein relate to an apparatus for wireless communication. The apparatus may include means for receiving a measurement resource. The apparatus may include means for performing an L3 measurement of the measurement resource independent of a requirement for the apparatus to use a first polarization that is dedicated for performing L3 measurements, in response to the apparatus supporting use of the first polarization for L3 measurements. The apparatus may include means for performing the L3 measurement of the measurement resource using a polarization of a most recent serving cell downlink communication in response to the apparatus not supporting use of the first polarization for L3 measurements.

Some aspects described herein relate to an apparatus for wireless communication. The apparatus may include means for receiving polarization information for measuring a measurement resource. The apparatus may include means for receiving the measurement resource. The apparatus may include means for performing an L3 measurement of the measurement resource based at least in part on the polarization information.

Some aspects described herein relate to an apparatus for wireless communication. The apparatus may include means for calculating a maximum quantity of measurement resources supported by the apparatus based at least in part on a configured timing for handling a mismatch between a polarization of a measurement resource and a polarization configured at the apparatus. The apparatus may include means for receiving the measurement resource. The apparatus may include means for performing an L3 measurement of the measurement resource based at least in part on the maximum quantity of measurement resources supported by the apparatus.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a regenerative satellite deployment and an example of a transparent satellite deployment in a non-terrestrial network (NTN), in accordance with the present disclosure.

FIG. 4 is a diagram illustrating an example of linear polarization and circular polarization, in accordance with the present disclosure.

FIG. 5A and FIG. 5B are diagrams illustrating examples and of coverage areas served by one or more polarizations, in accordance with the present disclosure.

FIG. 6A is a diagram illustrating an example of a physical channel and reference signals in a wireless network, in accordance with the present disclosure.

FIG. 6B is a diagram illustrating an example of a slot format, in accordance with the present disclosure.

FIG. 7 is a diagram illustrating an example of a signal and a reflected signal, in accordance with aspects of the present disclosure.

FIG. 8A is a diagram illustrating an example of a user plane protocol stack and a control plane protocol stack for a base station and a core network in communication with a UE, in accordance with the present disclosure.

FIG. 8B is a diagram illustrating an example of a control plane protocol stack for a base station and a core network in communication with a UE, in accordance with the present disclosure.

FIG. 9 is a diagram illustrating an example of performing a Layer 3 (L3) measurement in association with a dedicated polarization, in accordance with the present disclosure.

FIG. 10 is a diagram illustrating an example of a call flow for performing an L3 measurement in association with a dedicated polarization, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example implementation of code and circuitry for an apparatus, in accordance with the present disclosure.

FIG. 18 is a diagram of an example apparatus for wireless communication, in accordance with the present disclosure.

FIG. 19 is a diagram illustrating an example of a hardware implementation for an apparatus employing a processing system, in accordance with the present disclosure.

FIG. 20 is a diagram illustrating an example implementation of code and circuitry for an apparatus, in accordance with the present disclosure.

FIG. 21 is a diagram of an example apparatus for wireless communication, in accordance with the present disclosure.

FIG. 22 is a diagram illustrating an example of a hardware implementation for an apparatus employing a processing system, in accordance with the present disclosure.

FIG. 23 is a diagram illustrating an example implementation of code and circuitry for an apparatus, in accordance with the present disclosure.

FIG. 24 is a diagram of an example apparatus for wireless communication, in accordance with the present disclosure.

FIG. 25 is a diagram illustrating an example of a hardware implementation for an apparatus employing a processing system, in accordance with the present disclosure.

FIG. 26 is a diagram illustrating an example implementation of code and circuitry for an apparatus, in accordance with the present disclosure.

FIG. 27 is a diagram illustrating an example of an open radio access network (O-RAN) architecture, in accordance with the present disclosure.

### DETAILED DESCRIPTION

A wireless communication device may transmit or receive a communication with a beam that has a polarization. A polarization describes the way an electric field of an electromagnetic wave is oriented. Linear polarization occurs when the tip of the electric field of an electromagnetic wave at a fixed point in space oscillates along a straight line over time. Circular polarization occurs when the tip of the electric field of an electromagnetic wave at a fixed point in space traces a circle, and the electromagnetic wave may be formed by superposing two orthogonal linearly polarized waves of equal amplitude and a 90-degree phase difference. Portable devices, such as user equipments (UEs), may have varying polarizations due to movement or location. For example, a transmitting UE may move to a location in which a transmitted signal is reflected off of a surface (e.g., wall) to a receiving UE. The receiving UE may expect a receive polarization. However, the receive polarization may be a different polarization than expected due to the signal reflection off of the surface. The signal reflection may reverse or flip the polarization of the transmitted signal. If a polarization is different than expected, there may be a polarization mismatch and a loss of signal power.

According to one or more examples, a base station may indicate a cell-level polarization to a UE, similar to synchronization signal block (SSB) beams for New Radio (NR) beam management. A cell-level polarization may be a polarization indicated to all UEs in a cell. The base station may indicate a polarization relationship between a source transmission and a target transmission with respect to the base station and the UE, either of which may be the transmitter or the receiver. In one example, the base station may also indicate a UE-specific polarization, similar to channel state information reference signal (CSI-RS) beams for NR beam management. A UE-specific polarization may be a polarization indicated to a specific UE. However, because the UE's polarization (cell-level or UE-specific) may differ from a polarization of a neighboring cell, there may be an inter-cell polarization mismatch at the UE. Inter-system polarization mismatches may occur if different transmission systems or networks share the same frequency but have different polarizations. Inter-UE polarization mismatches may occur if a transmit polarization of another UE's uplink (causing cross-link interference (CLI)) is different than the polarization of the UE.

In an NR network, a radio resource control (RRC) layer handles communications related to configuring and operating the UE. The RRC layer in an NR protocol stack may be referred to as “Layer 3” or “L3”. L3 measurements are useful for radio resource management decisions that require a long term view of channel conditions. L3 measurements may be filtered at the L3 layer to remove the impact of fast fading (signal distortion occurs quickly in comparison to a time duration of a symbol) and to help reduce short term variations in signal strength or delay. For example, handover procedures are to be triggered after L3 filtering to reduce the risk of ping-pong between serving cells. L3 measurements may be either beam-level or cell-level and may be reported to the network within an RRC message as a measurement report (MR). A UE may perform an L3 measurement and report the L3 measurement to the network.

As described above, polarization mismatches may be an issue for L3 measurements. According to various aspects described herein, a UE may use one of several options associated with a polarization that is dedicated for L3 measurements of measurement resources. As a first option or aspect, the UE may avoid a polarization mismatch when performing an L3 measurement of a measurement resource by supporting a polarization that is dedicated for L3 measurements. That is, a UE may use a specified polarization when performing L3 measurements The polarization may be dedicated for a particular measurement resource. For example, a UE may use a polarization dedicated for measuring a CSI-RS for L3 filtering. Using the dedicated polarization for L3 measurements may improve the accuracy of the L3 measurements.

As a second option or aspect, the UE may support a dedicated polarization for L3 measurements but may not be required to use the dedicated polarization when performing L3 measurements. The L3 measurements may be for interference management because the actual interference observed by the UE may be in the polarization for the UE's serving cell signal. As a third option or aspect, the UE may support a dedicated polarization for L3 measurements based at least in part on whether the UE has a UE capability for using a dedicated polarization. The UE may use at least one of these options or aspects, or an appropriate combination thereof, based at least in part on a type of the measurement resource.

In some aspects, the UE may use a most recent serving cell downlink communication to measure a measurement resource. The network may provide polarization information (e.g., polarization configuration field, measurement target identifier (ID)) for the measurement resource. In some aspects, the UE may handle a polarization mismatch (e.g., perform L3 measurements or not perform L3 measurements) based at least in part on a type of polarization mismatch (e.g., linear polarization mismatch, circular polarization mismatch), a UE capability for handling polarization mismatches, and/or a UE behavior for handling polarization mismatches that is specified in stored configuration information.

As a result of the aspects described above, the UE and the base station may improve the accuracy of L3 measurements when the UE receives a signal with a polarization that is different than an expected polarization for which antennas of the UE are configured. More accurate L3 measurements improve communications. Improved communications enhance the user experience and conserve processing resources and signaling resources that would otherwise be consumed with retransmissions or actions caused by short-term variations in signal strength or quality.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

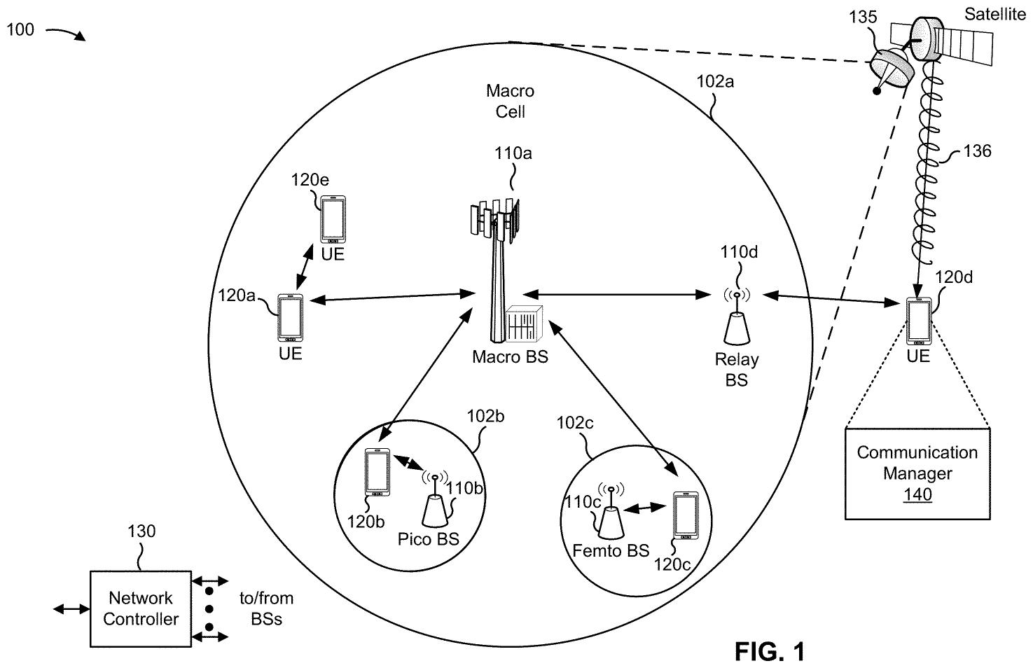

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, as shown, a cell may be provided by a base station 110 of a non-terrestrial network (NTN). As used herein, “non-terrestrial network” may refer to a network for which access is provided by a non-terrestrial base station, such as a base station carried by a satellite, a balloon, a dirigible, an airplane, an unmanned aerial vehicle, and/or a high altitude platform station. A base station in an NTN (NTN entity) may use a circular polarization. For example, a base station in a satellite 135 (NTN entity) may transmit a communication to the UE 120 using a circular polarization 136.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In one or more examples, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a measurement resource and perform an L3 measurement of the measurement resource using a first polarization that is dedicated for performing L3 measurements and that is supported by the UE.

In some aspects, the communication manager 140 may receive a measurement resource and perform an L3 measurement of the measurement resource independent of a requirement for the UE to use a first polarization that is dedicated for performing L3 measurements, in response to the UE supporting use of the first polarization for L3 measurements. The communication manager 140 may perform the L3 measurement of the measurement resource using a polarization of a most recent serving cell downlink communication in response to the UE not supporting use of the first polarization for L3 measurements.

In some aspects, the communication manager 140 may receive polarization information for measuring a measurement resource, receive the measurement resource, and perform an L3 measurement of the measurement resource based at least in part on the polarization information.

In some aspects, the communication manager 140 may calculate a maximum quantity of measurement resources supported by the UE based at least in part on a configured timing for handling a mismatch between a polarization of a measurement resource and a polarization configured at the UE, receive the measurement resource on a measurement resource, and perform an L3 measurement of the measurement resource based at least in part on the maximum quantity of measurement resources supported by the UE. Additionally, or alternatively, the communication manager 140 may perform one or more other operations described herein.

As indicated above, FIG. 1 is provided as an example. Other examples may differ from what is described with regard to FIG. 1.

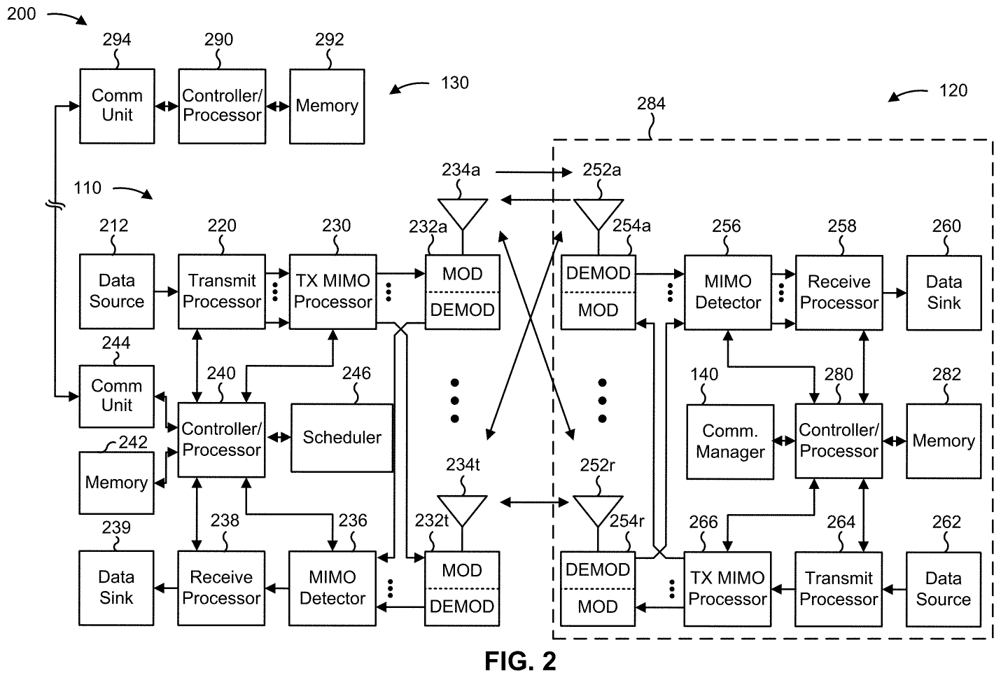

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t. The base station 110 may be an NTN entity located in a terrestrial location or in a non-terrestrial location (e.g., satellite 135).

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

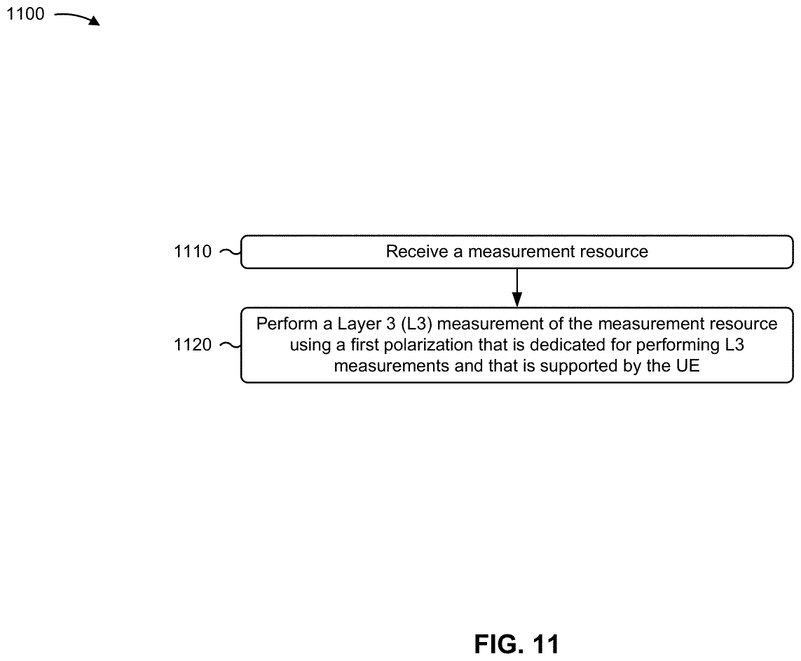

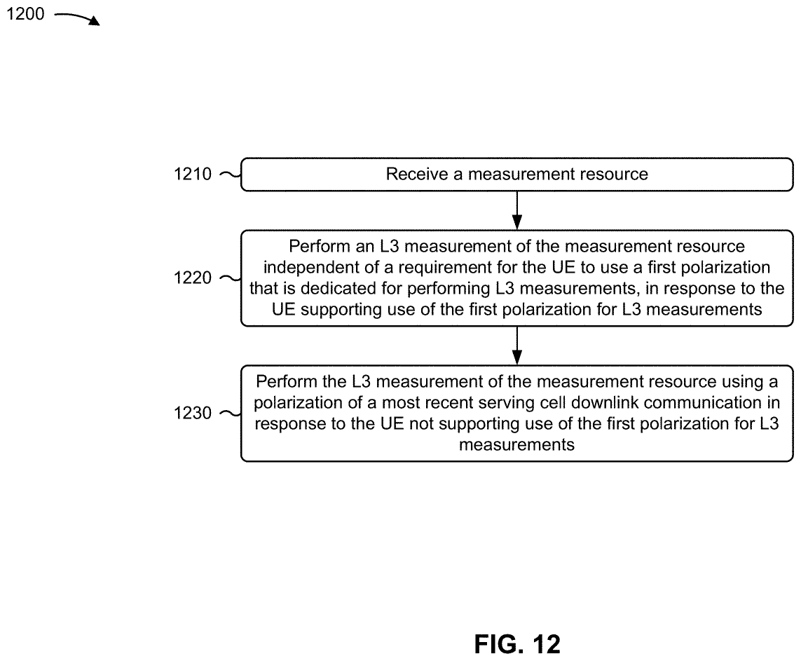

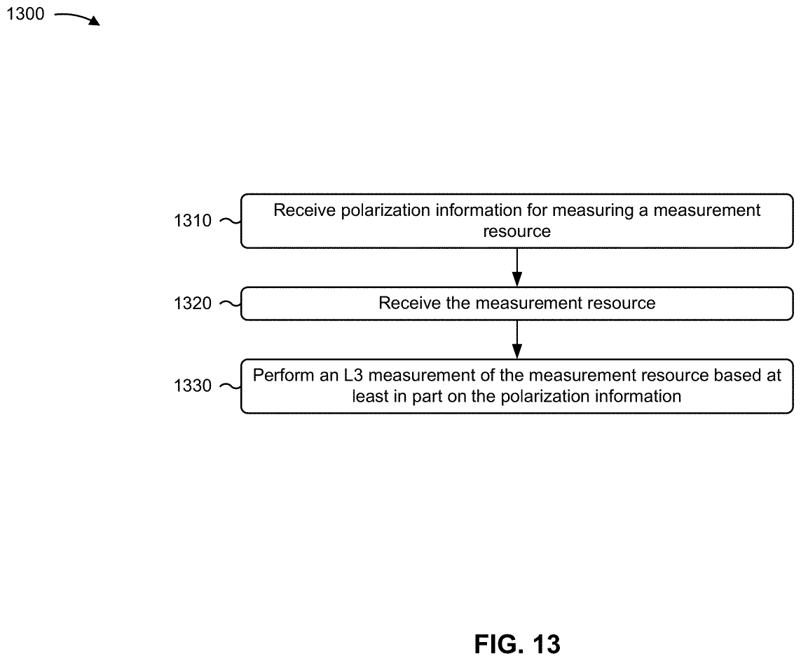

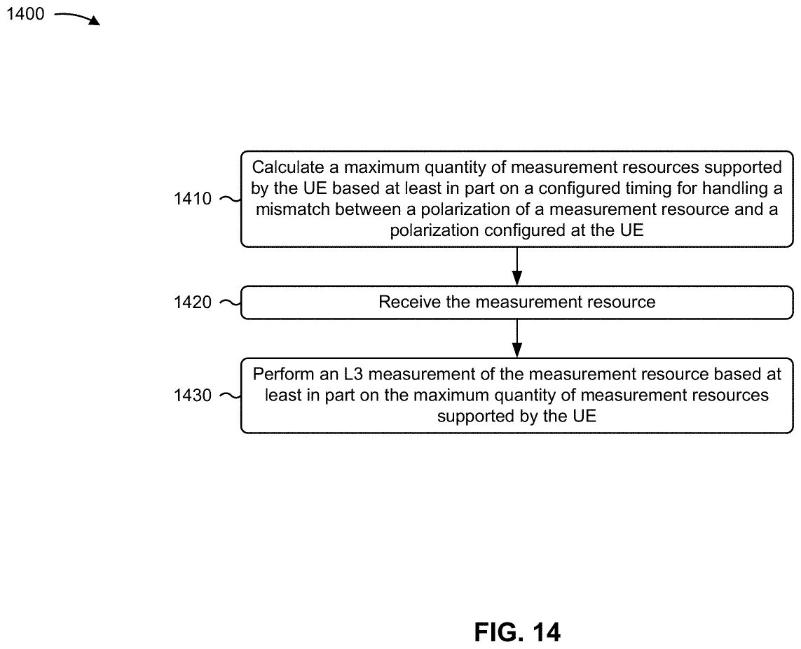

The controller/processor 240 of the base station 110, the controller/processor 280 of the UE 120, and/or any other component(s) of FIG. 2 may perform one or more techniques associated with performing an L3 measurement using a dedicated polarization, as described in more detail elsewhere herein. For example, a controller/processor of an NTN entity (e.g., controller/processor 240 of base station 110), controller/processor 280 of UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110, an NTN entity, and/or the UE 120, may cause the one or more processors, the UE 120, and/or the base station 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving a measurement resource; and/or means for performing an L3 measurement of the measurement resource using a first polarization that is dedicated for performing L3 measurements and that is supported by the UE 120.

In some aspects, the UE 120 includes means for receiving a measurement resource; means for performing an L3 measurement of the measurement resource independent of a requirement for the UE 120 to use a first polarization that is dedicated for performing L3 measurements, in response to the UE 120 supporting use of the first polarization for L3 measurements; and/or means for performing the L3 measurement of the measurement resource using a polarization of a most recent serving cell downlink communication in response to the UE 120 not supporting use of the first polarization for L3 measurements.

In some aspects, the UE 120 includes means for receiving polarization information for measuring a measurement resource; means for receiving the measurement resource; and/or means for performing an L3 measurement of the measurement resource based at least in part on the polarization information.

In some aspects, the UE 120 includes means for calculating a maximum quantity of measurement resources supported by the UE 120 based at least in part on a configured timing for handling a mismatch between a polarization of a measurement resource and a polarization configured at the UE 120; means for receiving the measurement resource; and/or means for performing an L3 measurement of the measurement resource based at least in part on the maximum quantity of measurement resources supported by the UE 120. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

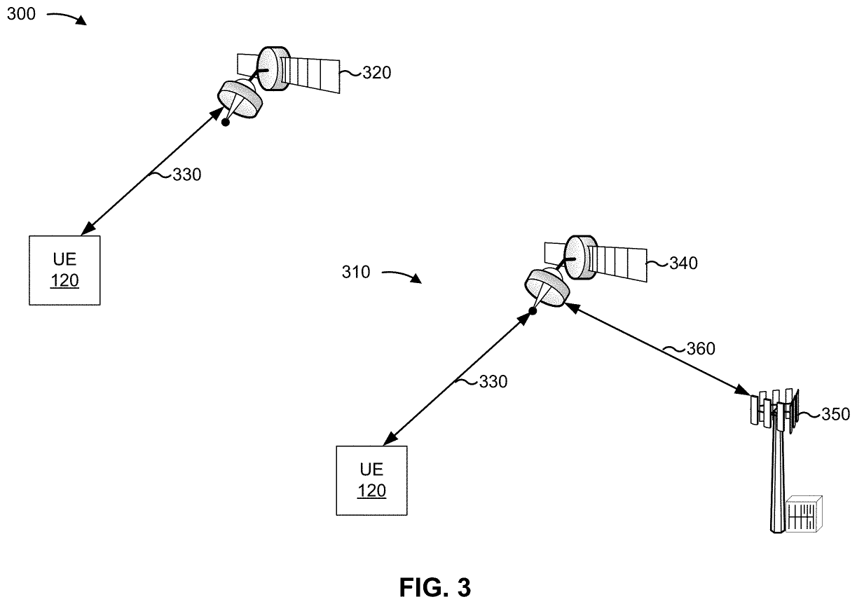

FIG. 3 is a diagram illustrating an example 300 of a regenerative satellite deployment and an example 310 of a transparent satellite deployment in an NTN, in accordance with the present disclosure.

Example 300 shows a regenerative satellite deployment. In example 300, a UE 120 is served by a satellite 320 (e.g., satellite 135) via a service link 330. For example, the satellite 320 may include a BS 110 (e.g., BS 110a), and/or a gNB. In some aspects, the satellite 320 may be referred to as a non-terrestrial base station, a regenerative repeater, an on-board processing repeater, and/or an NTN entity. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may also be considered to be an NTN entity. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify and/or filter the uplink radio frequency transmission. In some aspects, the UEs 120 shown in example 300 and example 310 may be associated with a Global Navigation Satellite System (GNSS) capability, a Global Positioning System (GPS) capability, and/or the like, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

As indicated above, FIG. 3 is provided as an example. Other examples may differ from what is described with regard to FIG. 3.

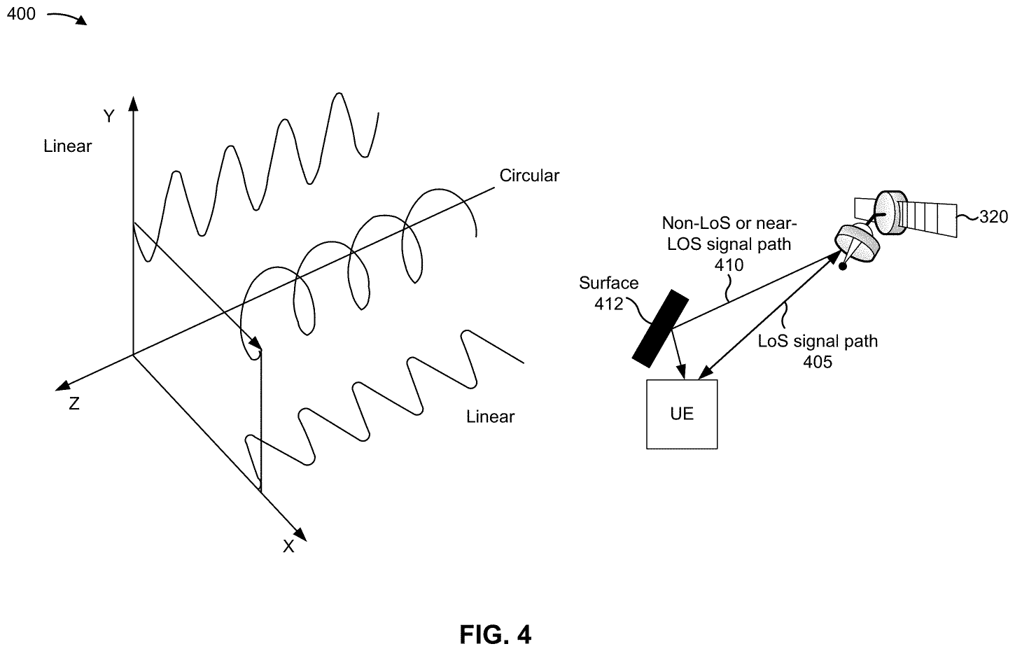

FIG. 4 is a diagram illustrating an example 400 of linear polarization and circular polarization, in accordance with the present disclosure.

An NTN entity may transmit and receive with beams that have a polarization. Linear polarization occurs when the tip of the electric field of an electromagnetic wave at a fixed point in space oscillates along a straight line over time. Circular polarization occurs when the tip of the electric field of an electromagnetic wave at a fixed point in space traces a circle, and the electromagnetic wave may be formed by superposing two orthogonal linearly polarized waves of equal amplitude and a 90-degree phase difference. A circular polarization may be a right-hand circular polarization (RHCP) or a left-hand circular polarization (LHCP).

“Transmit polarization” may refer to a polarization associated with a transmission from an NTN entity or a UE, and “receive polarization” may refer to a polarization associated with a reception at the NTN entity or the UE. In one or more examples, the transmit polarization may be the same as the receive polarization for the same communication link. However, in one or more other examples, the transmit polarization may be different than the receive polarization, which may result in a polarization mismatch loss. For example, when the transmit polarization is RHCP and the receive polarization is LHCP, or vice versa, the polarization mismatch loss may be greater than 20 decibels (dB). When the transmit polarization is a circular polarization and the receive polarization is a linear polarization, or vice versa, the polarization mismatch loss may be about 3 dB. When the transmit polarization is a horizontal linear polarization and the receive polarization is a vertical linear polarization, or vice versa, the polarization mismatch loss may be greater than 20 dB.

Portable devices, such as UEs, may have varying polarization due to movement. Further, linear polarization (e.g., horizontal linear polarization or vertical linear polarization) may be less reliable than circular polarization for portable devices with respect to frequency reuse. Frequency reuse may occur when a specified range of frequencies are used more than once in a same radio system, so that a total capacity of the radio system is increased without increasing an allocated bandwidth of the radio system.

A UE having a polarization capability may be able to detect a polarization and/or transmit signals with the polarization. For example, a UE having a capability to use two circular polarization modes may be able to detect a circular polarization associated with one of the two circular polarization modes. A UE with two linearly cross-polarized antennas may detect and transmit signals using both circular polarizations.

Polarization detection may increase processing at the UE and thus a polarization may be signaled to the UE. A base station, such as a base station located at satellite 320, may indicate a polarization to the UE. In some aspects, the polarization indication may indicate a polarization relationship between a source transmission and a target transmission with respect to the base station and the UE. The polarization indication may indicate a polarization associated with a downlink transmission or an uplink transmission. Even when the UE has a capability to detect the polarization, the polarization indication may reduce an amount of processing that occurs at the UE.

A signaled polarization may be accurate for direct line of sight (LOS) communications, such as for downlink or uplink transmission on signal path 405. However, a non-LOS communication may be a reflected communication (e.g., signal path 410 reflected off surface 412), and a reflected communication may have a different polarization than a direct LOS communication. For example, an RHCP polarization of a downlink communication may become an LHCP polarization after being reflected off of a surface. That is, a best receive polarization for a downlink communication may be different than a polarization at the point of transmission. As for uplink communications, a UE may determine a best transmit polarization to correspond to a best receive polarization assuming downlink and uplink reciprocity (e.g., the uplink and the downlink are relatively close in frequency). However, the receive polarization may be different due to signal reflection. If a polarization is different than expected, there may be a polarization mismatch loss.

In some aspects, for LoS signal propagation, the polarization indication may avoid the polarization detection at the UE. In some aspects, for non-LoS and near-LoS signal propagation, the polarization indication may also be useful to the UE. For example, the polarization indication may enable the UE to determine a polarization of a first beam and a polarization of a second beam, and whether the polarization is the same or different with respect to the first beam and the second beam. For a downlink communication where the base station is transmitting and the UE is receiving, a receive polarization of the UE may be different from a transmit polarization of the base station. For an uplink communication where the UE is transmitting and the base station is receiving, a transmit polarization of the UE may correspond to a receive polarization of the base station, assuming downlink and uplink reciprocity (e.g., the uplink and the downlink are relatively close in frequency). For both the downlink and the uplink, the polarization indication may enable the UE to determine the transmit polarization of the base station or the receive polarization of the base station. In some aspects, the polarization indication may be specific to a measurement resource or a type of measurement resource.

As indicated above, FIG. 4 is provided as an example. Other examples may differ from what is described with regard to FIG. 4.

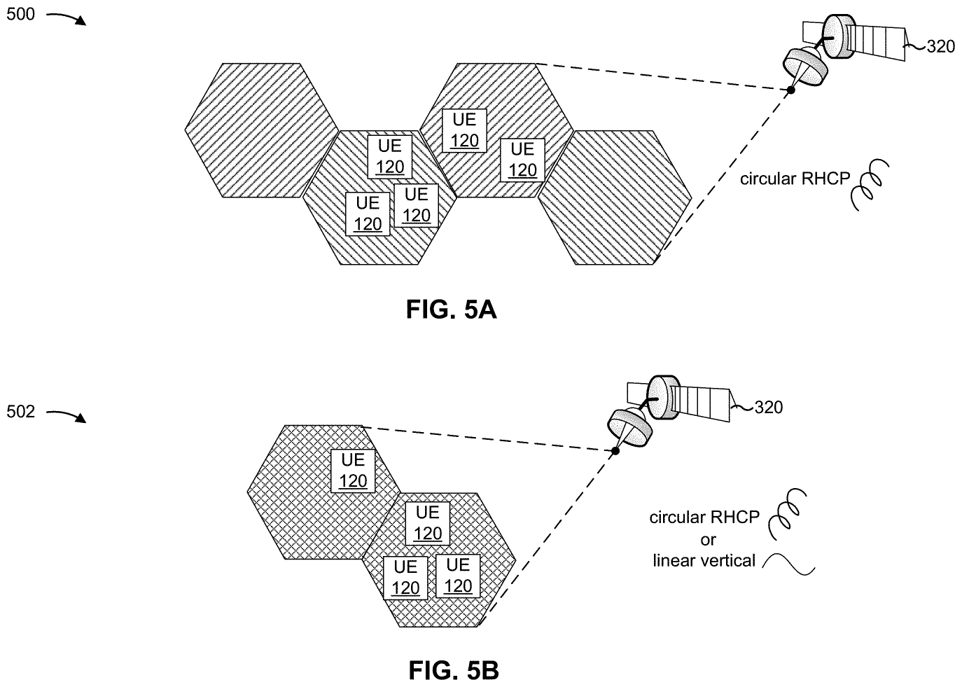

FIG. 5A and FIG. 5B are diagrams illustrating examples 500 and 502 of coverage areas served by one or more polarizations, in accordance with the present disclosure.

FIG. 5A and FIG. 5B how coverage areas or cells provided by an NTN entity, such as a non-terrestrial base station or a non-terrestrial relay station. The NTN entity may generate multiple beams associated with respective frequency regions. In some aspects, a beam may be an analog beam (e.g., generated by a cone antenna or a different type of antenna). In some aspects, the beam may be a digital beam, which may be formed by signal manipulation across an antenna array.

As shown by reference number 500 in FIG. 5A, a coverage area (e.g., of 4 regions) may be served by one polarization to increase a system capacity. One polarization for the coverage area served by satellite 320 may be beneficial (e.g., higher received signal power) when the coverage area is associated with a sparse constellation of UEs (e.g., UE 120s), where the UEs are able to dynamically adjust a polarization. The polarization may be a circular polarization, such as an RHCP or an LHCP, or the polarization may be a linear polarization, such as a vertical linear polarization or a horizontal linear polarization. In example 500, the polarization is a circular RHCP polarization.

As shown by reference number 502 in FIG. 5B, a coverage area (e.g., of 2 regions) may be served by two polarizations to increase a system capacity. The two polarizations may be associated with a same frequency, or the two polarizations may be associated with different frequencies. Two polarizations for the coverage area served by satellite 320 may be beneficial when the coverage area is associated with a dense constellation of UEs. The two polarizations may be circular polarizations, or the two polarizations may be linear polarizations, or the two polarizations may be linear polarization and a circular polarization. In example 502, the polarizations are a circular RHCP and a linear vertical polarization. Different polarizations may be used for different measurement resources or types of measurement resources.

As indicated above, FIG. 5A and FIG. 5B provide some examples. Other examples may differ from what is described with regard to FIG. 5A and FIG. 5B.

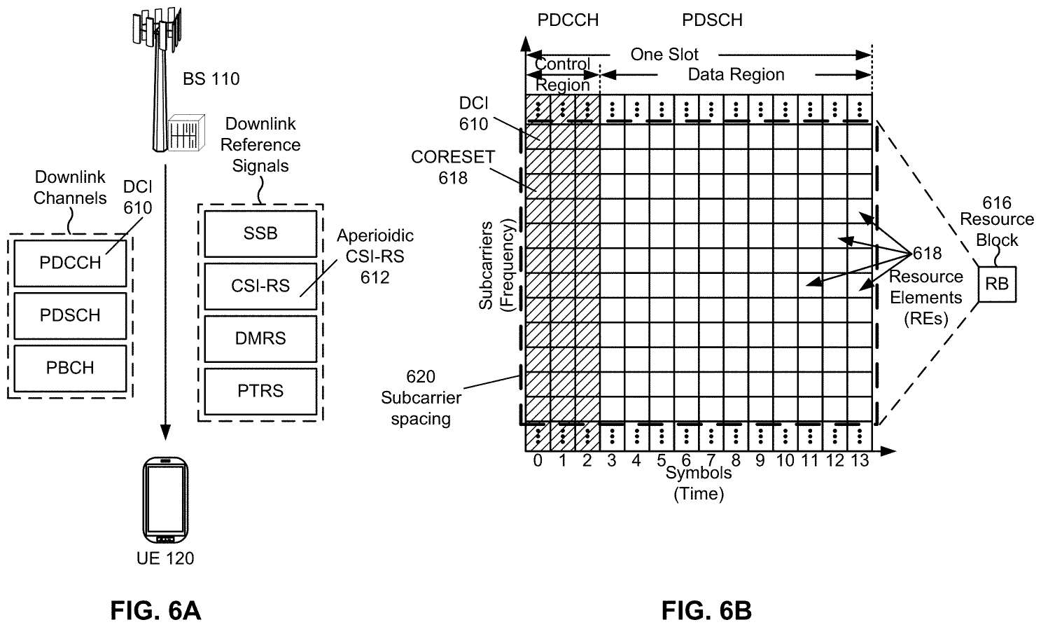

FIG. 6A is a diagram illustrating an example of a physical channel and reference signals in a wireless network, in accordance with the present disclosure. As shown in FIG. 6A, downlink channels and downlink reference signals may carry information from a base station 110 to a UE 120. The base station 110 may be an NTN entity (e.g., satellite 320) or may transmit and receive via an NTN entity.

A downlink channel may include a physical downlink control channel (PDCCH) that carries downlink control information (DCI) 610, a physical downlink shared channel (PDSCH) that carries downlink data, or a physical broadcast channel (PBCH) that carries system information, among other examples. In some aspects, PDSCH communications may be scheduled by PDCCH communications, including the DCI 610. A downlink reference signal may include an SSB, a CSI-RS, a DMRS, a positioning reference signal (PRS), or a phase tracking reference signal (PTRS), among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, an NTN entity (e.g., base station, relay station) may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The CSI-RS may be, for example, an aperiodic CSI-RS 612. The NTN entity may configure a set of CSI-RSs for the UE, and the UE may measure the configured set of CSI-RSs. Based at least in part on the measurements, the UE may perform channel estimation and may report channel estimation parameters to the NTN entity (e.g., in a CSI report), such as a CQI, a precoding matrix indicator (PMI), a CSI-RS resource indicator (CRI), a layer indicator (LI), a rank indicator (RI), or an RSRP, among other examples. The NTN entity or a base station may use the CSI report to select transmission parameters for downlink communications to the UE, such as a number of transmission layers (e.g., a rank), a precoding matrix (e.g., a precoder), an MCS, or a refined downlink beam (e.g., using a beam refinement procedure or a beam management procedure), among other examples.

As indicated above, FIG. 6A is provided as an example. Other examples may differ from what is described with regard to FIG. 6A.

FIG. 6B is a diagram illustrating an example of a slot format, in accordance with the present disclosure. As shown in FIG. 6B, time-frequency resources in a radio access network may be partitioned into resource blocks, shown by a single resource block (RB) 616. An RB 616 is sometimes referred to as a physical resource block (PRB). An RB 616 includes a set of subcarriers (e.g., 12 subcarriers) and a set of symbols (e.g., 14 symbols) that are schedulable by a base station 110 as a unit. In some aspects, an RB 616 may include a set of subcarriers in a single slot. As shown, a single time-frequency resource included in an RB 616 may be referred to as a resource element (RE) 618. An RE 618 may include a single subcarrier (e.g., in frequency) and a single symbol (e.g., in time). A symbol may be referred to as an orthogonal frequency division multiplexing (OFDM) symbol. An RE 618 may be used to transmit one modulated symbol, which may be a real value or a complex value. The DCI 610 may be found in a control region (e.g., PDCCH).

In some telecommunication systems (e.g., NR), RBs 616 may span 12 subcarriers with a subcarrier spacing (SCS) 620 of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured. Each communication on the PDCCH or the PDSCH may have a linear polarization or a circular polarization.

As indicated above, FIG. 6B is provided as an example. Other examples may differ from what is described with regard to FIG. 6B.

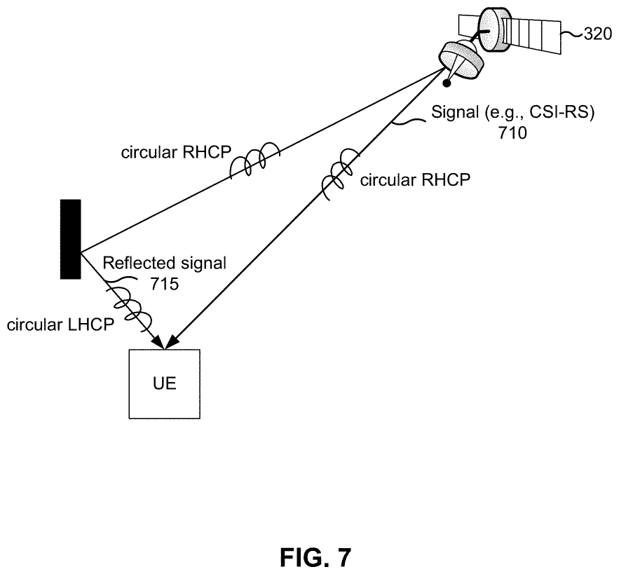

FIG. 7 is a diagram illustrating an example of a signal 710 and a reflected signal 715, in accordance with aspects of the present disclosure. A base station, such as an NTN entity (e.g., satellite 320), may transmit a CSI-RS with a polarization, including a circular polarization. However, an antenna configuration of a UE (e.g., UE 120) may not be arranged for the same polarization as the CSI-RS. This may be due to a reflection of the signal 710 carrying the CSI-RS, which changes a polarization of the signal. In fact, the reflected signal 715 may have a polarization that is the same polarization, an orthogonal polarization, or a polarization that is neither the same polarization nor an orthogonal polarization. For example, a CSI-RS may have an RHCP at the point of transmission from satellite 320, but after being reflected off a wall, the CSI-RS may have an LHCP when the CSI-RS is received by the UE. If the UE is expecting the CSI-RS to be RHCP (based on a signaled polarization of the CSI-RS), the antennas will be configured for RHCP. However, if the reflected CSI-RS is LHCP, the difference between RHCP and LHCP may result in a polarization mismatch loss that causes a measurement of the reference signal to be inaccurate or to fail. Inaccurate measurements can degrade communications or cause retransmissions that would be a waste of power, processing resources, and signaling resources.

A base station may indicate a polarization (e.g., circular polarization) to a UE. In some aspects, the polarization indication may indicate a polarization relationship between a source transmission and a target transmission with respect to the base station and the UE. In some aspects, the polarization indication may indicate a polarization associated with a downlink transmission or an uplink transmission. The polarization indication may help to avoid a polarization mismatch loss at the UE, which may occur when the UE cannot detect the polarization and a mismatch occurs between a transmit polarization and a receive polarization. Even when the UE has a capability to detect the polarization, the polarization indication signaling may reduce an amount of processing that occurs at the UE.

In some aspects, a configuration for the downlink may indicate a polarization relationship between the downlink transmission and a reference signal (e.g., an SSB or a CSI-RS), and the UE may derive the polarization of the downlink transmission based at least in part on the polarization relationship indicated in the downlink configuration. The polarization relationship may be a parameter included in a transmission configuration indicator (TCI) state, which may be part of the downlink configuration transmitted from the base station to the UE. A TCI state may indicate a directionality or a characteristic of the downlink beam, such as one or more quasi-co-location (QCL) properties of the downlink beam.

In some aspects, the downlink configuration may explicitly indicate the polarization associated with the downlink transmission. The polarization associated with the downlink transmission may correspond to a polarization associated with the reference signal (e.g., an SSB or a CSI-RS), or the polarization associated with the downlink transmission may be different (e.g., orthogonal) than the polarization associated with the reference signal. In some aspects, a downlink transmission may have a polarization that is dedicated for L3 measurements.

As indicated above, FIG. 7 is provided as an example. Other examples may differ from what is described with regard to FIG. 7.

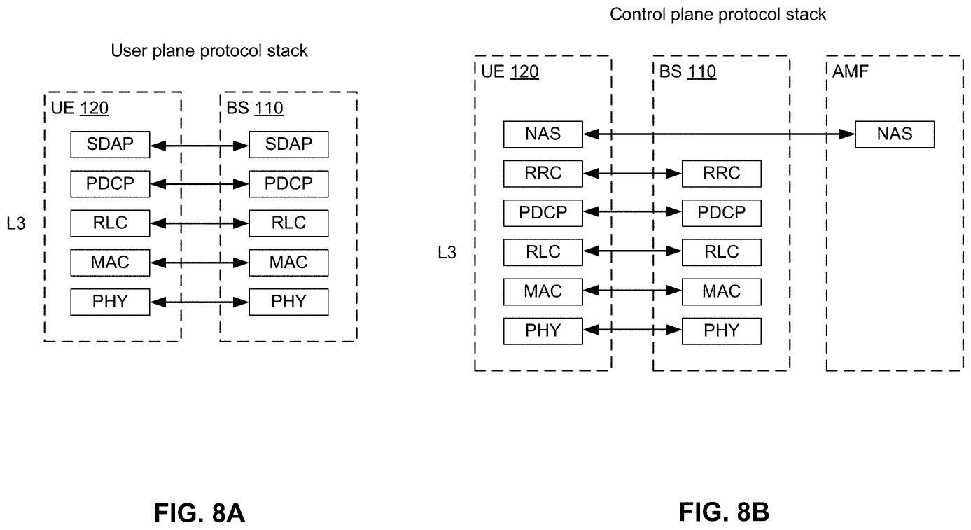

FIG. 8A is a diagram illustrating an example of a user plane protocol stack for a base station and a core network in communication with a UE, in accordance with the present disclosure. FIG. 8B is a diagram illustrating an example of a control plane protocol stack for the base station and the core network in communication with a UE, in accordance with the present disclosure.

On the user plane, the UE 120 and the BS 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the BS 110. On the control plane, the UE 120 and the BS 110 may include respective RRC layers. Furthermore, the UE 120 may include a non-access stratum (NAS) layer in communication with an NAS layer of an access and management mobility function (AMF). The AMF may be associated with a core network associated with the BS 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 8A, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as L3. L3 measurements may be measurements that are expected to be subject to L3 filtering at the L3.

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the BS 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARD), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the BS 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 8A and FIG. 8B are provided as examples. Other examples may differ from what is described with regard to FIG. 8A and FIG. 8B.

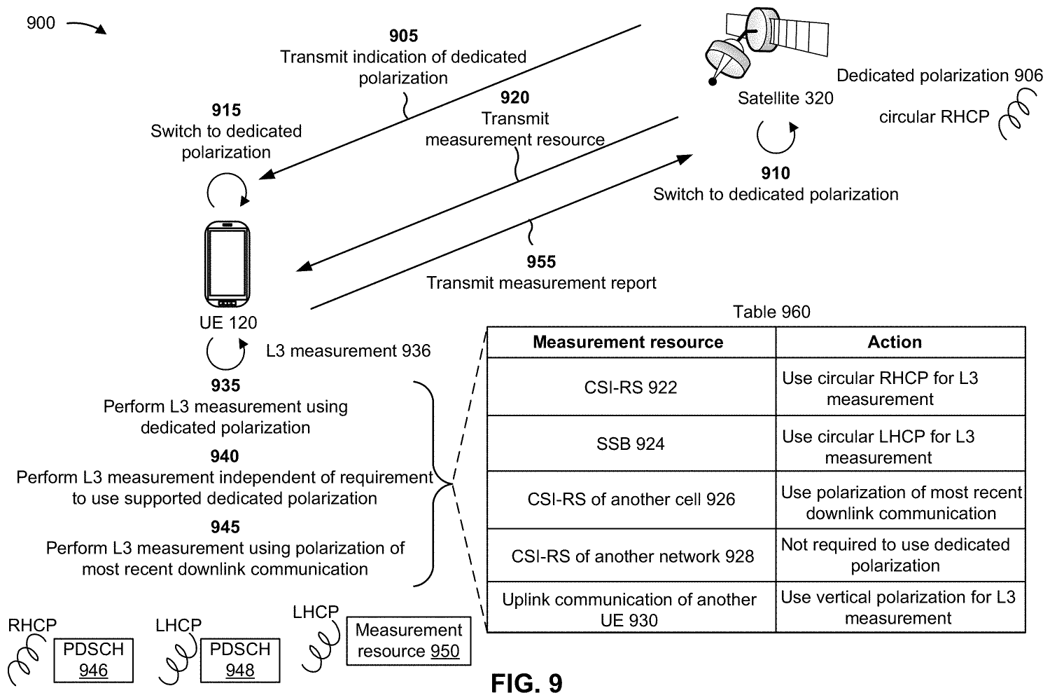

FIG. 9 is a diagram illustrating an example 900 of performing an L3 measurement in association with a dedicated polarization, in accordance with the present disclosure. As shown, FIG. 9 includes a UE (e.g., UE 120) and an NTN entity (e.g., satellite 320), which may be a base station or a relay station. In some aspects, the UE 120 may include a ground station.

The NTN entity or another base station may indicate a cell-level polarization or a UE-specific polarization to the UE. However, because the UE's polarization (cell-level or UE-specific) may differ from a polarization of a neighboring cell, a polarization of another coexisting system using the same frequency, or a transmit polarization of another UE's uplink (causing CLI), there may be a polarization mismatch at the UE.

As described above, the L3 (RRC layer) handles communications related to configuring and operating the UE. L3 measurements are useful for radio resource management decisions that require a long term view of channel conditions. L3 measurements may be filtered at the L3 to remove the impact of fast fading and to help reduce short term variations in results. For example, handover procedures are to be triggered after L3 filtering to reduce the risk of ping-pong between serving cells. A UE may perform an L3 measurement and report the L3 measurement to the network.

Polarization mismatches may be an issue for L3 measurements. According to various aspects described herein, a UE may use one of several options associated with supporting a polarization that is dedicated for L3 measurements. As a first option, the UE may avoid polarization mismatches when performing L3 measurements by supporting a polarization that is dedicated for L3 measurements. The polarization may be dedicated for a particular measurement resource. For example, a UE may use a polarization dedicated for measuring a CSI-RS for L3 filtering. Using the dedicated polarization for L3 measurements may improve the accuracy of the L3 measurements.

As a second option, the UE may support a dedicated polarization for L3 measurements but may not be required to use the dedicated polarization when performing L3 measurements. The L3 measurements in this option may be for interference management because the actual interference experienced by the UE may be in the polarization for the UE's serving cell signal. For example, a UE may not use a polarization dedicated for measuring a CLI measurement resource for L3 filtering. As a third option, the UE may support a dedicated polarization for L3 measurements based at least in part on whether the UE has a UE capability for using a dedicated polarization. The UE may use one of these options, or an appropriate combination thereof, based at least in part on a type of measurement resource.

In some aspects, the UE may use a polarization of a most recent serving cell downlink communication to measure a configured measurement resource. The network may provide polarization information (e.g., polarization configuration field, measurement target ID) for the configured measurement resource. In some aspects, the UE may handle a polarization mismatch (e.g., perform L3 measurements or not perform L3 measurements) based at least in part on a type of the polarization mismatch (e.g., linear polarization mismatch, circular polarization mismatch), a UE capability for handling polarization mismatches, and/or a UE behavior for handling polarization mismatches that is specified in stored configuration information.

As a result of the aspects described above, the UE and the base station may improve the accuracy of L3 measurements when the UE receives a signal with a polarization that is different than a polarization for which antennas of the UE are configured. More accurate L3 measurements improves communications.

FIG. 9 shows the three options described above. As shown by reference number 905, the satellite 320 (as a base station or a relay station) may transmit an indication of a polarization that is dedicated for performing L3 measurements, such as dedicated polarization 906. While any linear polarization or circular polarization may be used as a dedicated polarization, in example 900, the dedicated polarization 906 is an RHCP. The UE 120 may support the dedicated polarization 906. As shown by reference number 910, the satellite 320 may switch to the dedicated polarization 906 in preparation for transmitting a measurement resource, if the satellite is not already configured for the dedicated polarization 906. As shown by reference number 915, the UE 120 may switch to the dedicated polarization 906.

As shown by reference number 920, the satellite 320 may transmit the measurement resource. The measurement resource may be a time-frequency resource that is one of several different measurement resource types. For example, the measurement resource type may be a reference signal, such as a CSI-RS 922 or an SSB 924. The measurement resource type may be a CSI-RS 926 of another cell or a CSI-RS 928 of another network. The measurement resource type may be an uplink communication 930 of another UE.

In some aspects, for the first option, the UE 120 may perform an action that is associated with the dedicated polarization 906 for L3 measurements. The UE 120 may support the dedicated polarization 906 for L3 measurements and may use the dedicated polarization to perform an L3 measurement, as shown by reference number 935. L3 measurement 936 may be a result of performing the L3 measurement. Alternatively, for the second option as shown by reference number 940, the UE 120 may perform an L3 measurement independent of any requirement to use the supported dedicated polarization 906.

Alternatively, for the third option as shown by reference number 945, the UE 120 may perform an L3 measurement using a polarization of a most recent downlink communication to the UE 120. This may be a scenario where the UE 120 does not support use of the dedicated polarization 906 for L3 measurements. The most recent downlink communication may be a most recent CSI-RS. The most recent downlink communication may include control information on a PDCCH or data on a PDSCH. For example, if a first PDSCH communication 946 (e.g., RHCP) and a second PDSCH communication 948 (e.g., LHCP) are received by the UE 120, the UE 120 may use the LHCP to perform an L3 measurement of the measurement resource 950. In some aspects, this action may be performed in response to a polarization of the measurement resource and a polarization configured at the UE 120 being the same.

In some aspects, the UE 120 may select which action (among the 3 options shown by reference numbers 935, 940, and 945) to perform based at least in part on the measurement resource type. FIG. 9 shows a table 960 of example actions that may be performed according to measurement resource type. For example, if the measurement resource type is a CSI-RS 922, the UE 120 may use a circular RHCP (e.g., configure the antennas of the UE 120 for circular RHCP) for performing an L3 measurement. If the measurement resource type is an SSB 924, the UE 120 may use a LHCP for an L3 measurement. If the measurement type is a CSI-RS 926 of another cell, the UE 120 may use a polarization of a most recent downlink communication. If the measurement type is a CSI-RS 928 of another network, the UE 120 may not be required to use the supported dedicated polarization 906. If the measurement type is an uplink communication 930 of another UE, the UE 120 may use a vertical polarization for an L3 measurement. FIG. 9 shows example actions to take for example measurement resource types, but other measurement resource type-action combinations may be appropriate for L3 measurements.

As shown by reference number 955, the UE 120 may transmit a measurement report that includes the L3 measurement 936. By performing actions associated with a dedicated polarization for L3 measurements, the UE 120 may improve the flexibility and accuracy of L3 measurements. As a result, the UE 120 and the network may make better decisions for handling communications, which conserves processing resources and signaling resources.

As indicated above, FIG. 9 is provided as an example. Other examples may differ from what is described with regard to FIG. 9.

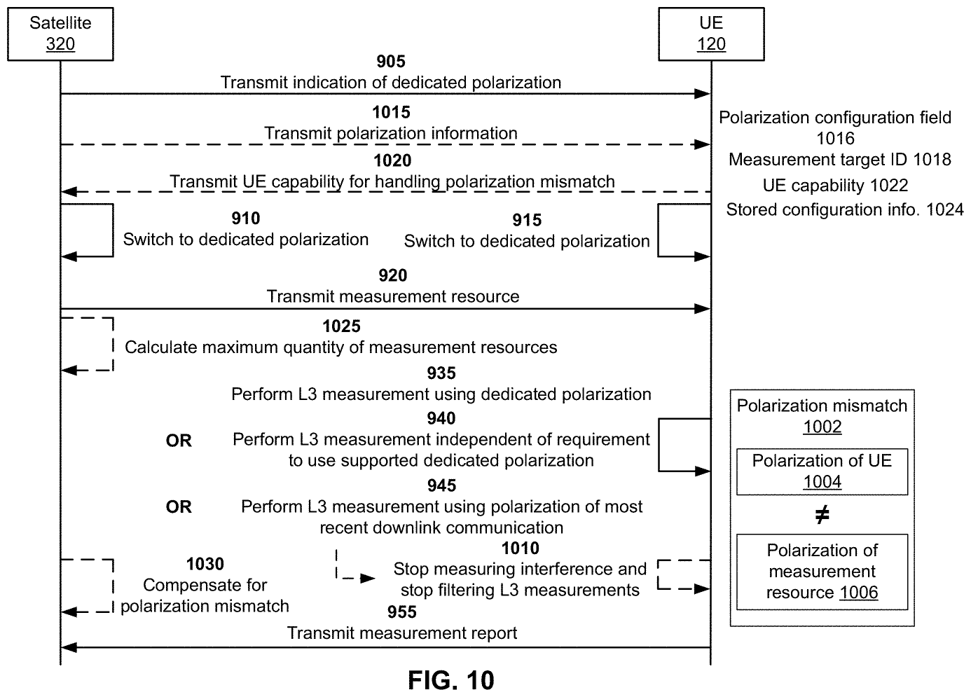

FIG. 10 is a diagram illustrating an example of a call flow for performing an L3 measurement in association with a dedicated polarization, in accordance with the present disclosure. FIG. 10 corresponds to the operations described for FIG. 9.

As shown by reference number 905, the satellite 320 (as a base station or a relay station) may transmit an indication of the dedicated polarization. As shown by reference number 910, the satellite 320 may switch to the dedicated polarization in preparation for transmitting a measurement resource. As shown by reference number 915, the UE 120 may switch to the dedicated polarization 906.

As shown by reference number 920, the satellite 320 may transmit the measurement resource. The UE 120 may perform at least one of several actions. In some aspects, as shown by reference number 935, the UE 120 may use the dedicated polarization to perform an L3 measurement. Alternatively, in some aspects, as shown by reference number 940, the UE 120 may perform an L3 measurement independent of any requirement to use the supported dedicated polarization 906.

Alternatively, in some aspects, as shown by reference number 945, the UE 120 may perform an L3 measurement using a polarization of a most recent downlink communication in the serving cell to the UE 120. In some aspects, the UE 120 may use the polarization of the most recent downlink communication in response to a polarization mismatch 1002 (between a polarization 1004 for which the UE 120 is configured and a polarization 1006 of the measurement resource) not being a circular polarization mismatch (being a linear polarization mismatch). A circular polarization mismatch may be when polarization 1004 is an LHCP and polarization 1006 is an RHCP or when polarization 1004 is an RHCP and polarization 1006 is an LHCP. A linear polarization mismatch may be when polarization 1004 is a vertical polarization and polarization 1006 is a horizontal polarization or when polarization 1004 is a horizontal polarization and polarization 1006 is a vertical polarization. In some aspects, the UE 120 may use the polarization of the most recent downlink communication in response to a polarization mismatch 1002 not being a linear polarization mismatch (being a circular polarization mismatch).

In some aspects, the UE 120 may use the most recent downlink communication (as shown by reference number 945) or perform another action (e.g., as shown by reference number 935 or reference number 940) based at least in part on a UE capability of the UE 120 to handle a polarization mismatch. That is, the UE 120 may measure the measurement resource for L3 filtering based at least in part on whether polarization 1004 matches polarization 1006. For example, the UE 120 may measure the measurement resource in response to polarization 1004 matching polarization 1006. Alternatively, the UE 120 may not measure the measurement resource in response to a circular polarization mismatch or a linear polarization mismatch.

The polarization mismatch 1002 may be due to dynamic or different cell semi-static polarizations of the UE 120 and the transmitter of the measurement resource. If the UE 120 uses a polarization of the most recent serving cell downlink communication, the UE 120 may stop measuring interference and stop the filtering of L3 measurements, as shown by reference number 1010. As shown by reference number 955, the UE 120 may transmit a measurement report that includes the L3 measurement 936.

In some aspects, the satellite 320 may transmit polarization information for a configured measurement resource, as shown by reference number 1015. The polarization information may include an additional polarization configuration field 1016 in a measurement resource configuration. The polarization configuration field 1016 may indicate a polarization to use for L3 measurements of the measurement resource. In some aspects, the polarization information may include an ID 1018 of a measurement target (e.g., UE ID, cell ID, network identity) if a polarization has been configured for the measurement target. As shown by reference number 935, the UE 120 may perform an L3 measurement using a dedicated polarization. This may include performing the L3 measurement based at least in part on the polarization information.

In some aspects, as shown by reference number 1020, the UE 120 may transmit a UE capability 1022 for handling polarization mismatches. The UE 120 may handle a polarization mismatch (e.g., perform L3 measurements, not perform L3 measurements) based at least in part on the UE capability 1022 or stored configuration information 1024 (e.g., standard specification).

For UE measurements, there may be a limitation for the quantity of measurement resources that can be supported by the UE 120. With UE polarization mismatch handling, this limit may need to be reevaluated. In some aspects, as shown by reference number 1025, the UE 120 may calculate the maximum quantity of measurement resources that the UE can support based at least in part on a configured timing for handling the polarization mismatch 1002 between the polarization 1006 of the measurement resource and the polarization 1004 configured at the UE. The configured timing may be before the UE 120 handles the polarization mismatch 1002 or after the UE 120 handles the polarization mismatch 1002. For example, the UE 120 may calculate the maximum quantity after the UE 120 handles the polarization mismatch 1002 (reflecting actual maximum computational efforts by the UE 120) or before the UE 120 handles the polarization mismatch 1002 (not taking a polarization mismatch into account). The UE 120 may handle the polarization mismatch 1002 based at least in part on a specified UE behavior for handling polarization mismatches or a reported UE capability for handling polarization mismatches. A UE behavior may include one or more rules for handling polarization mismatches (e.g., perform L3 measurement or not perform L3 measurement based at least in part on a polarization mismatch or a type of polarization mismatch).

As shown by reference number 935, the UE 120 may perform an L3 measurement using a dedicated polarization. This may include performing the L3 measurement based at least in part on the maximum quantity of measurement resources. For example, if a current quantity of measurement resources for which the UE 120 is to perform L3 measurements is less than the maximum quantity, the UE 120 may perform an L3 measurement on the next measurement resource. If the current quantity of measurement resources meets or exceeds the maximum quantity, the UE 120 may stop performing L3 measurements.

For L3 measurements, the UE 120 may filter a raw measurement result of a measurement resource (measurement result from a single resource occasion) via an infinite input response (IIR) filter, which is a filter that reduces the random fluctuation of a response to an input. For CLI, an impact of the change of a UE's receive beam is random and cannot be quantized. For polarization mismatches, the impact is predictable and can be compensated with the filtering. In some aspects, the UE 120 may stop measuring interference and stop filtering measurement results in response to the polarization mismatch 1002. The UE 120 may stop the L3 filtering after the most recent PDSCH communication and before the next measurement resource.

In some aspects, as shown by reference number 1030, the UE 120 may compensate for the polarization mismatch 1002 before filtering an L3 measurement. This may include adding a specified gain value (e.g., 3 dB) to the L3 measurement. For example, in response to the UE 120 obtaining a raw measurement of 3 dB of a measurement resource where there is a polarization mismatch 1002 between the UE 120 and the measurement resource, the UE 120 may add 3 dB to the raw measurement such that the raw measurement is 6 dB. The UE 120 may then proceed with L3 filtering that includes the raw measurement of 6 dB. The specified gain value may be in a range between 2 dB and 4 dB, between 2.5 dB and 3.5 dB, between 2.9 dB and 3.1 dB, between 2.99 and 3.01, or the like. In this way, the L3 measurement may be more accurate.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with performing an L3 measurement that is associated with a dedicated polarization.

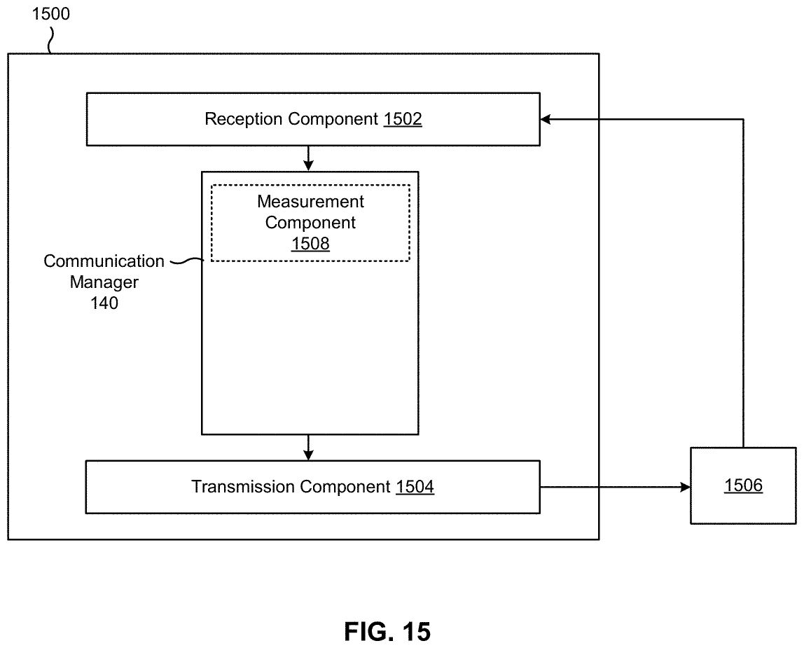

As shown in FIG. 11, in some aspects, process 1100 may include receiving a measurement resource (block 1110). For example, the UE (e.g., using communication manager 140 and/or reception component 1502 depicted in FIG. 15) may receive a measurement resource, as described above.

As further shown in FIG. 11, in some aspects, process 1100 may include performing an L3 measurement of the measurement resource using a first polarization that is dedicated for performing L3 measurements and that is supported by the UE (block 1120). For example, the UE (e.g., using communication manager 140 and/or measurement component 1508 depicted in FIG. 15) may perform an L3 measurement of the measurement resource using a first polarization that is dedicated for performing L3 measurements and that is supported by the UE, as described above.

Process 1100 may include additional aspects, such as any single aspect or any combination of aspects described below and/or in connection with one or more other processes described elsewhere herein.

In a first aspect, performing the L3 measurement of the measurement resource includes performing the L3 measurement of the measurement resource based at least in part on a UE capability of using the first polarization for performing L3 measurements on the measurement resource.

In a second aspect, alone or in combination with the first aspect, process 1100 includes receiving an indication of the first polarization.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated performing an L3 measurement that is associated with a dedicated polarization.

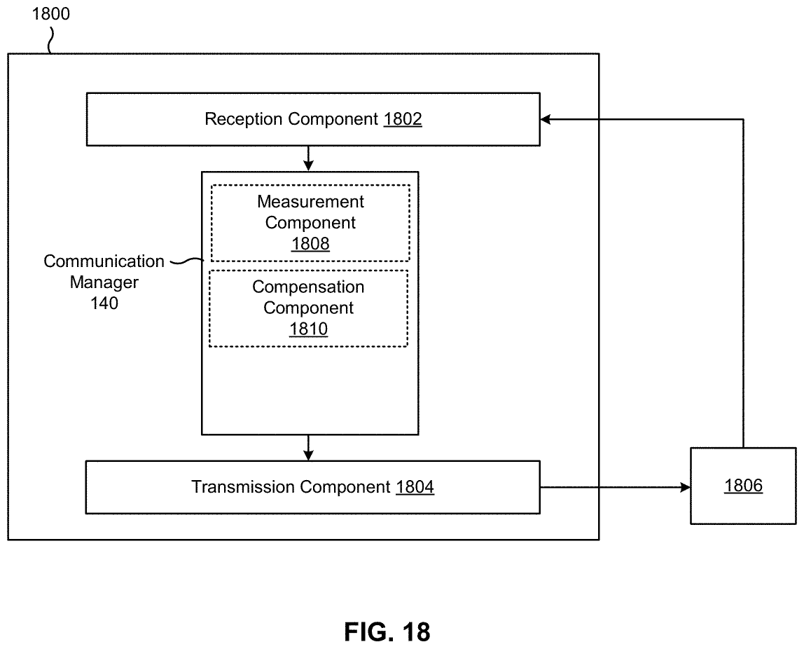

As shown in FIG. 12, in some aspects, process 1200 may include receiving a measurement resource (block 1210). For example, the UE (e.g., using communication manager 140 and/or reception component 1802 depicted in FIG. 18) may receive a measurement resource, as described above.

As further shown in FIG. 12, in some aspects, process 1200 may include performing an L3 measurement of the measurement resource independent of a requirement for the UE to use a first polarization that is dedicated for performing L3 measurements, in response to the UE supporting use of the first polarization for L3 measurements (block 1220). For example, the UE (e.g., using communication manager 140 and/or measurement component 1808 depicted in FIG. 18) may perform an L3 measurement of the measurement resource independent of a requirement for the UE to use a first polarization that is dedicated for performing L3 measurements, in response to the UE supporting use of the first polarization for L3 measurements, as described above.

As further shown in FIG. 12, in some aspects, process 1200 may include performing the L3 measurement of the measurement resource using a polarization of a most recent serving cell downlink communication in response to the UE not supporting use of the first polarization for L3 measurements (block 1230). For example, the UE (e.g., using communication manager 140 and/or measurement component 1808 depicted in FIG. 18) may perform the L3 measurement of the measurement resource using a polarization of a most recent serving cell downlink communication in response to the UE not supporting use of the first polarization for L3 measurements, as described above.

Process 1200 may include additional aspects, such as any single aspect or any combination of aspects described below and/or in connection with one or more other processes described elsewhere herein.

In a first aspect, performing the L3 measurement using the polarization of the most recent serving cell downlink communication includes performing the L3 measurement in response to a polarization of the measurement resource and a polarization configured at the UE being the same.

In a second aspect, alone or in combination with the first aspect, performing the L3 measurement using the polarization of the most recent serving cell downlink communication includes performing the L3 measurement in response to a mismatch between a polarization of the measurement resource and a polarization configured at the UE being a linear polarization mismatch. In a third aspect, alone or in combination with one or more of the first and second aspects, process 1200 includes stopping measuring interference and stopping filtering of L3 measurements.

In a fourth aspect, alone or in combination with one or more of the first through third aspects, performing the L3 measurement using the polarization of the most recent serving cell downlink communication includes performing the L3 measurement in response to a mismatch between a polarization of the measurement resource and a polarization configured at the UE being a circular polarization mismatch. In a fifth aspect, alone or in combination with one or more of the first through fourth aspects, process 1200 includes stopping measuring interference and stopping filtering of L3 measurements.

In a sixth aspect, alone or in combination with one or more of the first through fifth aspects, performing the L3 measurement using the polarization of the most recent serving cell downlink communication includes performing the L3 measurement based at least in part on a capability of the UE to handle a polarization mismatch.

In a seventh aspect, alone or in combination with one or more of the first through sixth aspects, performing the L3 measurement using the polarization of the most recent serving cell downlink communication includes performing the L3 measurement based at least in part on a UE behavior for handling mismatches that is indicated by stored configuration information.

In an eighth aspect, alone or in combination with one or more of the first through seventh aspects, process 1200 includes compensating for a polarization mismatch before filtering the L3 measurement. In a ninth aspect, alone or in combination with one or more of the first through eighth aspects, compensating for the polarization mismatch includes adding a specified gain value to the L3 measurement. In a tenth aspect, alone or in combination with one or more of the first through ninth aspects, the specified gain value is 3 dB, or a value between (inclusive of) 2.9 dB and 3.1 dB or between 2.99 dB and 3.01 dB.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with performing an L3 measurement that is associated with a dedicated polarization.

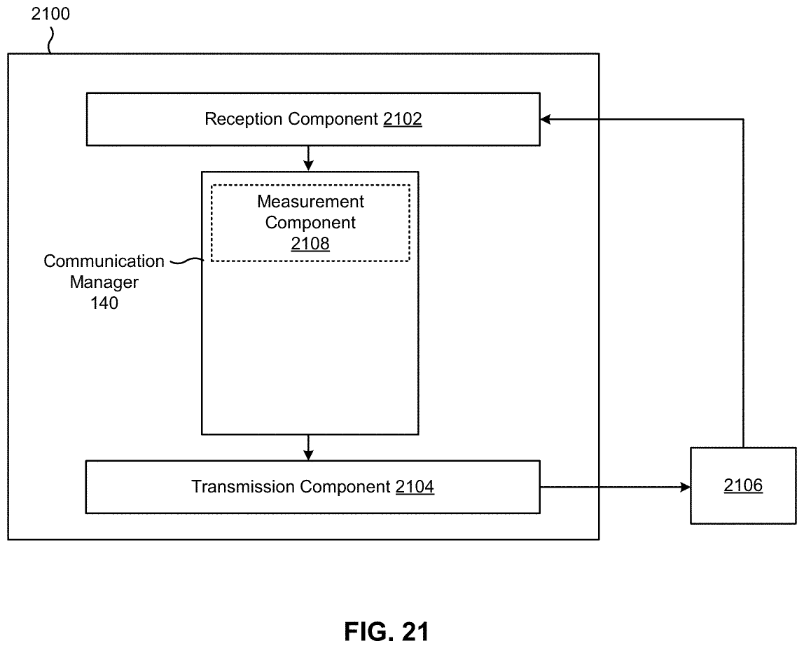

As shown in FIG. 13, in some aspects, process 1300 may include receiving polarization information for measuring a measurement resource (block 1310). For example, the UE (e.g., using communication manager 140 and/or reception component 2102 depicted in FIG. 21) may receive polarization information for measuring a measurement resource, as described above.

As further shown in FIG. 13, in some aspects, process 1300 may include receiving the measurement resource (block 1320). For example, the UE (e.g., using communication manager 140 and/or reception component 2102 depicted in FIG. 21) may receive the measurement resource, as described above.

As further shown in FIG. 13, in some aspects, process 1300 may include performing an L3 measurement of the measurement resource based at least in part on the polarization information (block 1330). For example, the UE (e.g., using communication manager 140 and/or measurement component 2108 depicted in FIG. 21) may perform an L3 measurement of the measurement resource based at least in part on the polarization information, as described above.

Process 1300 may include additional aspects, such as any single aspect or any combination of aspects described below and/or in connection with one or more other processes described elsewhere herein.

In a first aspect, receiving the polarization information includes receiving the polarization information in a polarization configuration field in a measurement resource configuration.

In a second aspect, alone or in combination with the first aspect, receiving the polarization information includes receiving an ID of a measurement target in response to a polarization configured at the UE being configured for the measurement target.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with performing an L3 measurement based at least in part on a maximum quantity of measurement resources.

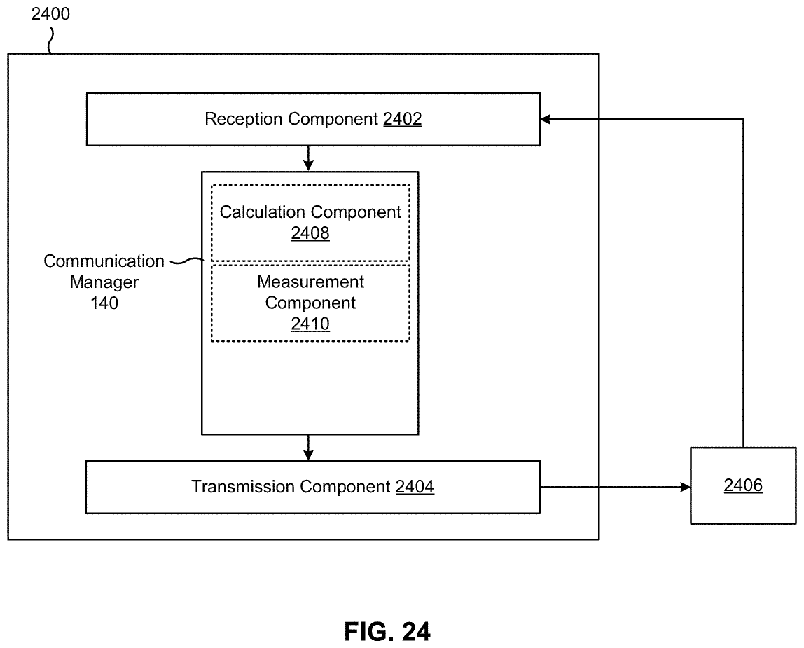

As shown in FIG. 14, in some aspects, process 1400 may include calculating a maximum quantity of measurement resources supported by the UE based at least in part on a configured timing for handling a mismatch between a polarization of a measurement resource and a polarization configured at the UE (block 1410). For example, the UE (e.g., using communication manager 140 and/or calculation component 2408 depicted in FIG. 24) may calculate a maximum quantity of measurement resources supported by the UE based at least in part on a configured timing for handling a mismatch between a polarization of a measurement resource and a polarization configured at the UE, as described above.

As further shown in FIG. 14, in some aspects, process 1400 may include receiving the measurement resource (block 1420). For example, the UE (e.g., using communication manager 140 and/or reception component 2402 depicted in FIG. 24) may receive the measurement resource, as described above.

As further shown in FIG. 14, in some aspects, process 1400 may include performing an L3 measurement of the measurement resource based at least in part on the maximum quantity of measurement resources supported by the UE (block 1430). For example, the UE (e.g., using communication manager 140 and/or measurement component 2410 depicted in FIG. 24) may perform an L3 measurement of the measurement resource based at least in part on the maximum quantity of measurement resources supported by the UE, as described above.

Process 1400 may include additional aspects, such as any single aspect or any combination of aspects described below and/or in connection with one or more other processes described elsewhere herein.

In a first aspect, calculating the maximum quantity of measurement resources supported by the UE based at least in part on the configured timing includes calculating the maximum quantity of measurement resources supported by the UE after handling the mismatch.

In a second aspect, alone or in combination with the first aspect, calculating the maximum quantity of measurement resources supported by the UE based at least in part on the configured timing includes calculating the maximum quantity of measurement resources supported by the UE before handling the mismatch.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE (e.g., a UE 120), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include a measurement component 1508, among other examples.

In some aspects, the apparatus 1500 may be configured to perform one or more operations described herein in connection with FIGS. 1-10. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive a measurement resource. The measurement component may perform an L3 measurement of the measurement resource using a first polarization that is dedicated for performing L3 measurements and that is supported by the UE. The reception component 1502 may receive an indication of the first polarization.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

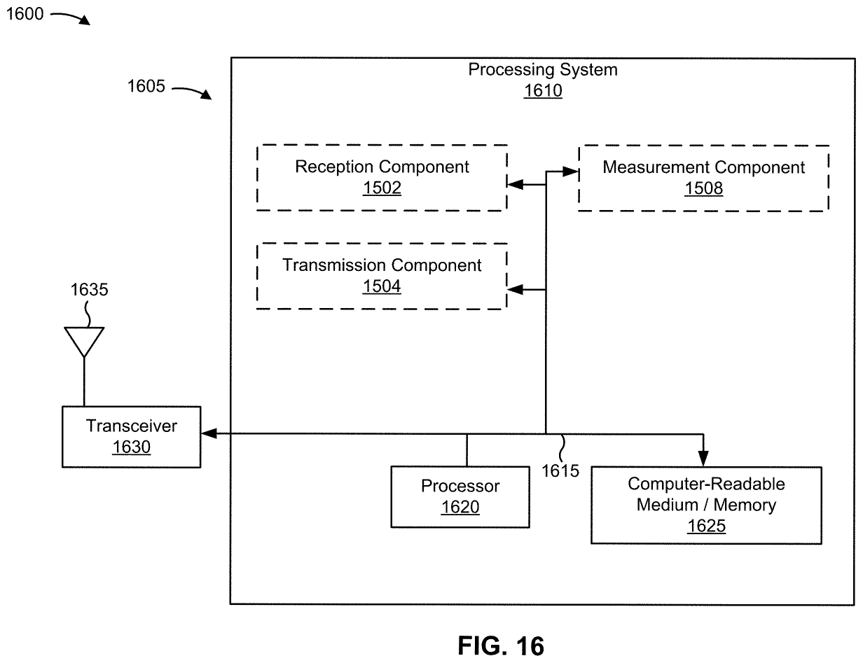

FIG. 16 is a diagram illustrating an example 1600 of a hardware implementation for an apparatus 1605 employing a processing system 1610. The apparatus 1605 may be a UE (e.g., UE 120).

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes a processor 1620 coupled to a computer-readable medium/memory 1625. The processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer-readable medium/memory 1625, one or more hardware modules coupled to the processor 1620, or some combination thereof.

In some aspects, the processing system 1610 may be a component of the UE 120 and may include the memory 282 and/or at least one of the TX MIMO processor 266, the receive (RX) processor 258, and/or the controller/processor 280. In some aspects, the apparatus 1605 for wireless communication includes means for receiving a measurement resource; and/or means for performing an L3 measurement of the measurement resource using a first polarization that is dedicated for performing L3 measurements and that is supported by the UE. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 16 is provided as an example. Other examples may differ from what is described in connection with FIG. 16.

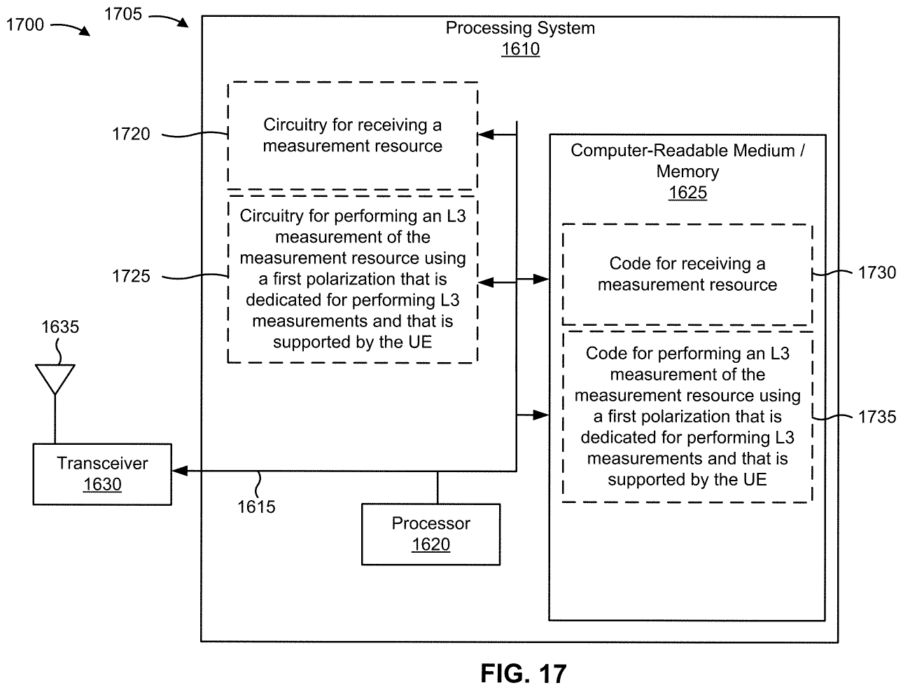

FIG. 17 is a diagram illustrating an example 1700 of an implementation of code and circuitry for an apparatus 1705. Apparatus 1705 may be a UE (e.g., UE 120).

As further shown in FIG. 17, the apparatus may include circuitry for receiving a measurement resource (circuitry 1720). For example, the apparatus may include circuitry to enable the apparatus to receive a measurement resource.

As further shown in FIG. 17, the apparatus may include circuitry for performing an L3 measurement of the measurement resource using a first polarization that is dedicated for performing L3 measurements and that is supported by the UE (circuitry 1725). For example, the apparatus may include circuitry to enable the apparatus to perform an L3 measurement of the measurement resource using a first polarization that is dedicated for performing L3 measurements and that is supported by the UE.

As further shown in FIG. 17, the apparatus may include, stored in computer-readable medium 1625, code for receiving a measurement resource (code 1730). For example, the apparatus may include code that, when executed by the processor 1620, may cause processor 1620 to cause the transceiver 1630 to receive a measurement resource.

As further shown in FIG. 17, the apparatus may include, stored in computer-readable medium 1625, code for performing an L3 measurement of the measurement resource using a first polarization that is dedicated for performing L3 measurements and that is supported by the UE (code 1735). For example, the apparatus may include code that, when executed by processor 1620, may cause processor 1620 to cause transceiver 1630 to perform an L3 measurement of the measurement resource using a first polarization that is dedicated for performing L3 measurements and that is supported by the UE.

FIG. 17 is provided as an example. Other examples may differ from what is described in connection with FIG. 17.

FIG. 18 is a diagram of an example apparatus 1800 for wireless communication. The apparatus 1800 may be a UE (e.g., a UE 120), or a UE may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 140. The communication manager 140 may include a measurement component 1808 and/or a compensation component 1810, among other examples.

In some aspects, the apparatus 1800 may be configured to perform one or more operations described herein in connection with FIGS. 1-10. Additionally, or alternatively, the apparatus 1800 may be configured to perform one or more processes described herein, such as process 1200 of FIG. 12. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

The reception component 1802 may receive a measurement resource. The measurement component 1808 may perform an L3 measurement of the measurement resource independent of a requirement for the UE to use a first polarization that is dedicated for performing L3 measurements, in response to the UE supporting use of the first polarization for L3 measurements. The measurement component 1808 may perform the L3 measurement of the measurement resource using a polarization of a most recent serving cell downlink communication in response to the UE not supporting use of the first polarization for L3 measurements.

The measurement component 1808 may stop measuring interference. The measurement component 1808 may stop filtering of L3 measurements. The compensation component 1810 may compensate for a polarization mismatch before filtering the L3 measurement.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

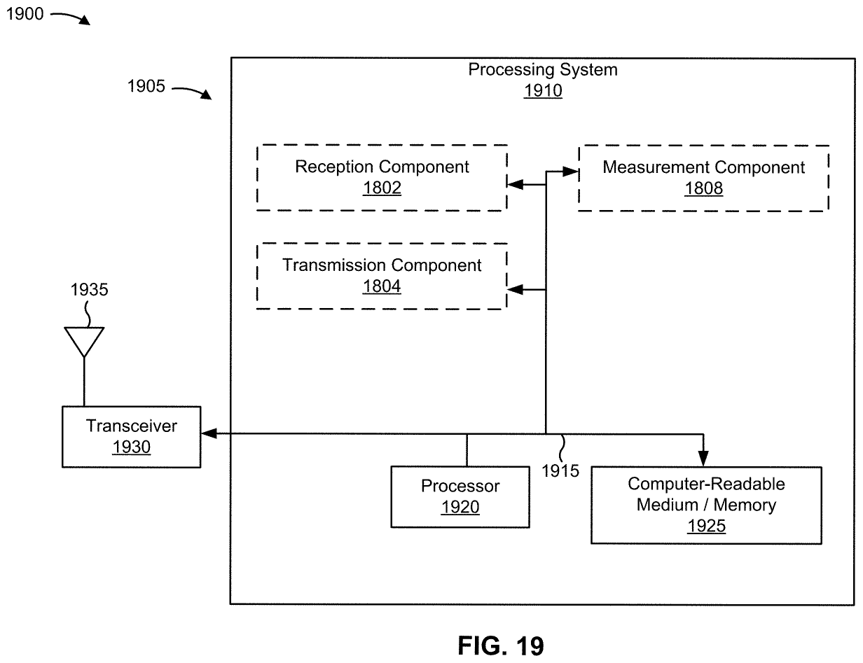

FIG. 19 is a diagram illustrating an example 1900 of a hardware implementation for an apparatus 1905 employing a processing system 1910. The apparatus 1905 may be a base station (e.g., base station 110, satellite 320).

The processing system 1910 may be implemented with a bus architecture, represented generally by the bus 1915. The bus 1915 may include any number of interconnecting buses and bridges depending on the specific application of the processing system 1910 and the overall design constraints. The bus 1915 links together various circuits including one or more processors and/or hardware components, represented by the processor 1920, the illustrated components, and the computer-readable medium/memory 1925. The bus 1915 may also link various other circuits, such as timing sources, peripherals, voltage regulators, and/or power management circuits.

The processing system 1910 may be coupled to a transceiver 1930. The transceiver 1930 is coupled to one or more antennas 1935. The transceiver 1930 provides a means for communicating with various other apparatuses over a transmission medium. The transceiver 1930 receives a signal from the one or more antennas 1935, extracts information from the received signal, and provides the extracted information to the processing system 1910, specifically the reception component 1802. In addition, the transceiver 1930 receives information from the processing system 1910, specifically the transmission component 1804, and generates a signal to be applied to the one or more antennas 1935 based at least in part on the received information.

The processing system 1910 includes a processor 1920 coupled to a computer-readable medium/memory 1925. The processor 1920 is responsible for general processing, including the execution of software stored on the computer-readable medium/memory 1925. The software, when executed by the processor 1920, causes the processing system 1910 to perform the various functions described herein for any particular apparatus. The computer-readable medium/memory 1925 may also be used for storing data that is manipulated by the processor 1920 when executing software. The processing system further includes at least one of the illustrated components. The components may be software modules running in the processor 1920, resident/stored in the computer-readable medium/memory 1925, one or more hardware modules coupled to the processor 1920, or some combination thereof.

In some aspects, the processing system 1910 may be a component of the base station 110 and may include the memory 242 and/or at least one of the TX MIMO processor 230, the RX processor 238, and/or the controller/processor 240. In some aspects, the apparatus 1905 for wireless communication includes means for receiving a measurement resource; means for performing an L3 measurement of the measurement resource independent of a requirement for the UE to use a first polarization that is dedicated for performing L3 measurements, in response to the UE supporting use of the first polarization for L3 measurements; and/or means for performing the L3 measurement of the measurement resource using a polarization of a most recent serving cell downlink communication in response to the UE not supporting use of the first polarization for L3 measurements. The aforementioned means may be one or more of the aforementioned components of the apparatus 1800 and/or the processing system 1910 of the apparatus 1905 configured to perform the functions recited by the aforementioned means. As described elsewhere herein, the processing system 1910 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 19 is provided as an example. Other examples may differ from what is described in connection with FIG. 19.

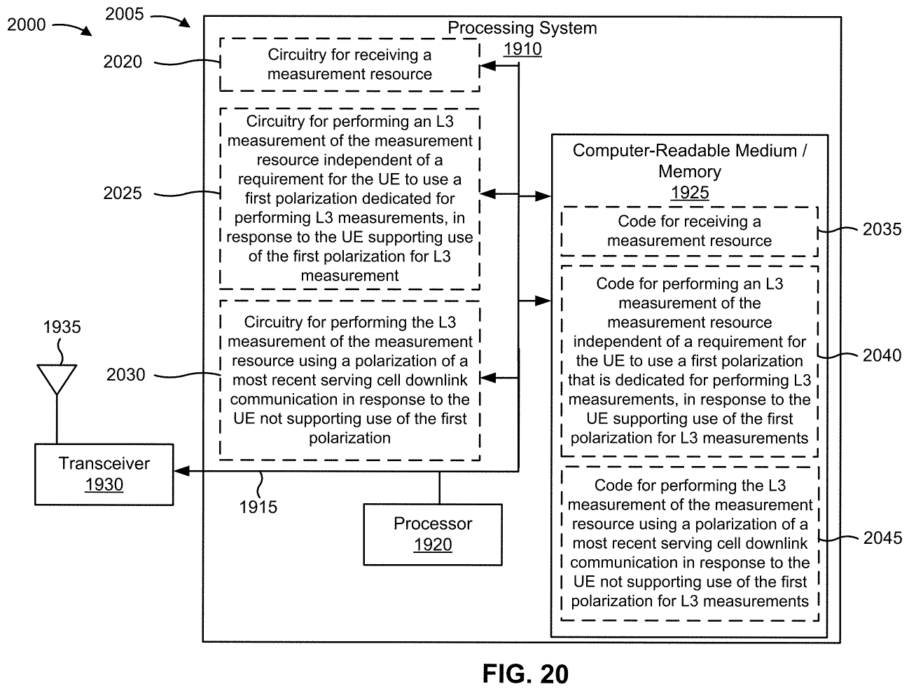

FIG. 20 is a diagram illustrating an example 2000 of an implementation of code and circuitry for an apparatus 2005. Apparatus 2005 may be a UE (e.g., UE 120).

As further shown in FIG. 20, the apparatus may include circuitry for receiving a measurement resource (circuitry 2020). For example, the apparatus may include circuitry to enable the apparatus to receive a measurement resource.

As further shown in FIG. 20, the apparatus may include circuitry for performing an L3 measurement of the measurement resource independent of a requirement for the UE to use a first polarization that is dedicated for performing L3 measurements, in response to the UE supporting use of the first polarization for L3 measurements (circuitry 2025). For example, the apparatus may include circuitry to enable the apparatus to perform an L3 measurement of the measurement resource independent of a requirement for the UE to use a first polarization that is dedicated for performing L3 measurements, in response to the UE supporting use of the first polarization for L3 measurements.

As further shown in FIG. 20, the apparatus may include circuitry for performing the L3 measurement of the measurement resource using a polarization of a most recent serving cell downlink communication in response to the UE not supporting use of the first polarization for L3 measurements (circuitry 2030). For example, the apparatus may include circuitry to enable the apparatus to perform the L3 measurement of the measurement resource using a polarization of a most recent serving cell downlink communication in response to the UE not supporting use of the first polarization for L3 measurements.

As further shown in FIG. 20, the apparatus may include, stored in computer-readable medium 1925, code for receiving a measurement resource (code 2035). For example, the apparatus may include code that, when executed by the processor 1920, may cause processor 1920 to cause transceiver 1930 to receive a measurement resource.

As further shown in FIG. 20, the apparatus may include, stored in computer-readable medium 1925, code for performing an L3 measurement of the measurement resource independent of a requirement for the UE to use a first polarization that is dedicated for performing L3 measurements, in response to the UE supporting use of the first polarization for L3 measurements (code 2040). For example, the apparatus may include code that, when executed by processor 1920, may cause processor 1920 to cause transceiver 1930 to perform an L3 measurement of the measurement resource independent of a requirement for the UE to use a first polarization that is dedicated for performing L3 measurements, in response to the UE supporting use of the first polarization for L3 measurements.

As further shown in FIG. 20, the apparatus may include, stored in computer-readable medium 1925, code for performing the L3 measurement of the measurement resource using a polarization of a most recent serving cell downlink communication in response to the UE not supporting use of the first polarization for L3 measurements (code 2045). For example, the apparatus may include code that, when executed by processor 1920, may cause processor 1920 to cause transceiver 1930 to perform the L3 measurement of the measurement resource using a polarization of a most recent serving cell downlink communication in response to the UE not supporting use of the first polarization for L3 measurements.

FIG. 20 is provided as an example. Other examples may differ from what is described in connection with FIG. 20.

FIG. 21 is a diagram of an example apparatus 2100 for wireless communication. The apparatus 2100 may be a UE (e.g., a UE 120), or a UE may include the apparatus 2100. In some aspects, the apparatus 2100 includes a reception component 2102 and a transmission component 2104, which may be in communication with one another (for example, via one or more buses and/or one or more other components). As shown, the apparatus 2100 may communicate with another apparatus 2106 (such as a UE, a base station, or another wireless communication device) using the reception component 2102 and the transmission component 2104. As further shown, the apparatus 2100 may include the communication manager 140. The communication manager 140 may include a measurement component 2108, among other examples.

In some aspects, the apparatus 2100 may be configured to perform one or more operations described herein in connection with FIGS. 1-10. Additionally, or alternatively, the apparatus 2100 may be configured to perform one or more processes described herein, such as process 1300 of FIG. 13. In some aspects, the apparatus 2100 and/or one or more components shown in FIG. 21 may include one or more components of the UE described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2106. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a demodulator, a MIMO detector, a receive processor, a controller/processor, a memory, or a combination thereof, of the UE described in connection with FIG. 2.

The transmission component 2104 may transmit communications, such as reference signals, control information, data communications, or a combination thereof, to the apparatus 2106. In some aspects, one or more other components of the apparatus 2100 may generate communications and may provide the generated communications to the transmission component 2104 for transmission to the apparatus 2106. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2106. In some aspects, the transmission component 2104 may include one or more antennas, a modem, a modulator, a transmit MIMO processor, a transmit processor, a controller/processor, a memory, or a combination thereof, of the UE described in connection with FIG. 2. In some aspects, the transmission component 2104 may be co-located with the reception component 2102 in a transceiver.

The reception component 2102 may receive polarization information for measuring a measurement resource. The reception component 2102 may receive the measurement resource. The measurement component 2108 may perform an L3 measurement of the measurement resource based at least in part on the polarization information.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

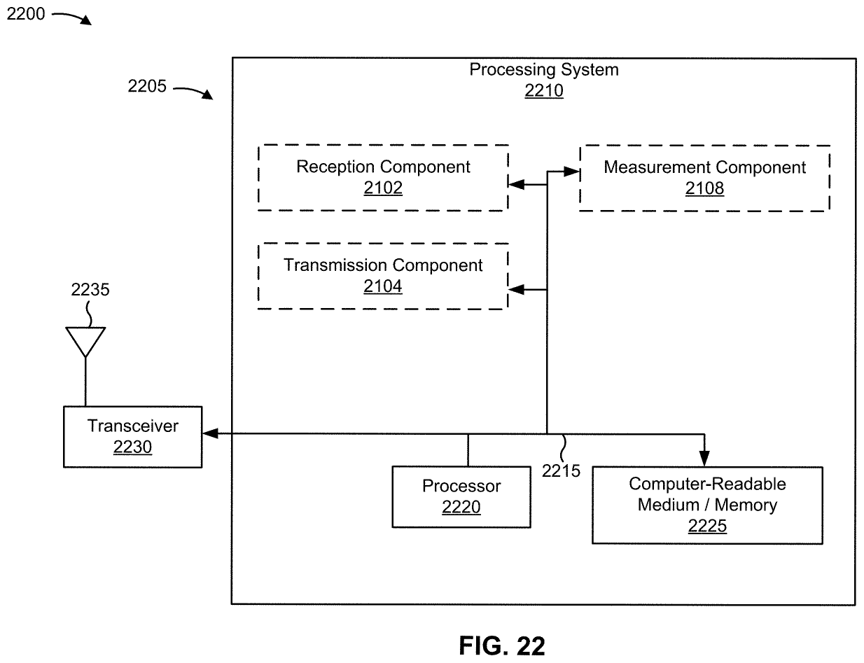

FIG. 22 is a diagram illustrating an example 2200 of a hardware implementation for an apparatus 2205 employing a processing system 2210. The apparatus 2205 may be a UE.

The processing system 2210 may be implemented with a bus architecture, represented generally by the bus 2215. The bus 2215 may include any number of interconnecting buses and bridges depending on the specific application of the processing system 2210 and the overall design constraints. The bus 2215 links together various circuits including one or more processors and/or hardware components, represented by the processor 2220, the illustrated components, and the computer-readable medium/memory 2225. The bus 2215 may also link various other circuits, such as timing sources, peripherals, voltage regulators, and/or power management circuits.

The processing system 2210 may be coupled to a transceiver 2230. The transceiver 2230 is coupled to one or more antennas 2235. The transceiver 2230 provides a means for communicating with various other apparatuses over a transmission medium. The transceiver 2230 receives a signal from the one or more antennas 2235, extracts information from the received signal, and provides the extracted information to the processing system 2210, specifically the reception component 2102. In addition, the transceiver 2230 receives information from the processing system 2210, specifically the transmission component 2104, and generates a signal to be applied to the one or more antennas 2235 based at least in part on the received information.

The processing system 2210 includes a processor 2220 coupled to a computer-readable medium/memory 2225. The processor 2220 is responsible for general processing, including the execution of software stored on the computer-readable medium/memory 2225. The software, when executed by the processor 2220, causes the processing system 2210 to perform the various functions described herein for any particular apparatus. The computer-readable medium/memory 2225 may also be used for storing data that is manipulated by the processor 2220 when executing software. The processing system further includes at least one of the illustrated components. The components may be software modules running in the processor 2220, resident/stored in the computer-readable medium/memory 2225, one or more hardware modules coupled to the processor 2220, or some combination thereof.

In some aspects, the processing system 2210 may be a component of the UE 120 and may include the memory 282 and/or at least one of the TX MIMO processor 266, the RX processor 258, and/or the controller/processor 280. In some aspects, the apparatus 2205 for wireless communication includes means for receiving a measurement resource; means for performing an L3 measurement of the measurement resource independent of a requirement for the UE to use a first polarization that is dedicated for performing L3 measurements, in response to the UE supporting use of the first polarization for L3 measurements; and means for performing the L3 measurement of the measurement resource using a polarization of a most recent serving cell downlink communication in response to the UE not supporting use of the first polarization for L3 measurements. The aforementioned means may be one or more of the aforementioned components of the apparatus 2100 and/or the processing system 2210 of the apparatus 2205 configured to perform the functions recited by the aforementioned means. As described elsewhere herein, the processing system 2210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 22 is provided as an example. Other examples may differ from what is described in connection with FIG. 22.

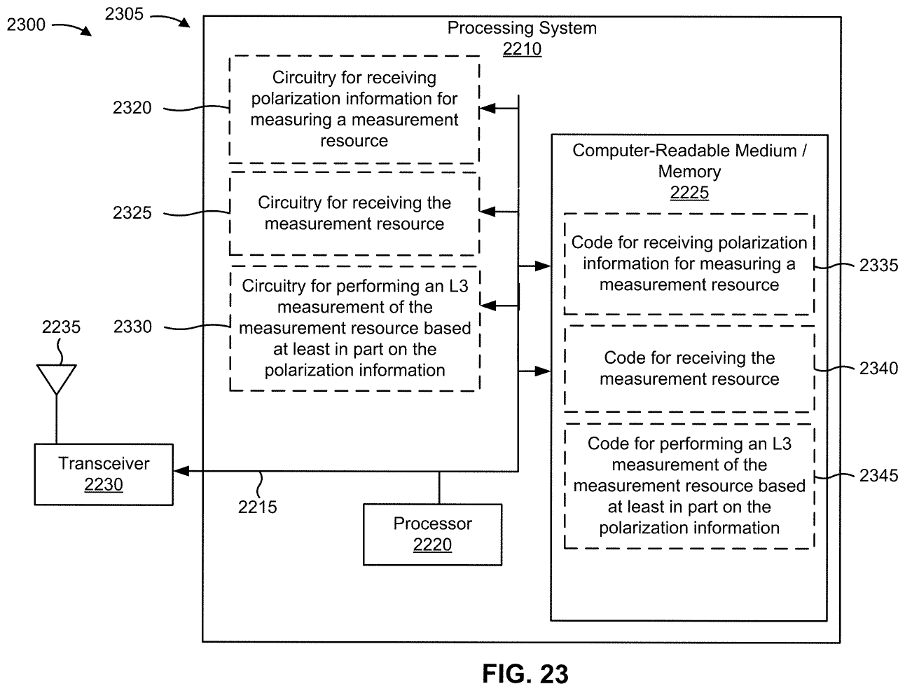

FIG. 23 is a diagram illustrating an example 2300 of an implementation of code and circuitry for an apparatus 2305. Apparatus 2305 may be a UE (e.g., UE 120).

As further shown in FIG. 23, the apparatus may include circuitry for receiving polarization information for measuring a measurement resource (circuitry 2320). For example, the apparatus may include circuitry to enable the apparatus to receive polarization information for measuring a measurement resource.

As further shown in FIG. 23, the apparatus may include circuitry for receiving the measurement resource (circuitry 2325). For example, the apparatus may include circuitry to enable the apparatus to receive the measurement resource.

As further shown in FIG. 23, the apparatus may include circuitry for performing an L3 measurement of the measurement resource based at least in part on the polarization information (circuitry 2330). For example, the apparatus may include circuitry to enable the apparatus to perform an L3 measurement of the measurement resource based at least in part on the polarization information.

As further shown in FIG. 23, the apparatus may include, stored in computer-readable medium 2225, code for receiving polarization information for measuring a measurement resource (code 2335). For example, the apparatus may include code that, when executed by the processor 2220, may cause processor 2220 to cause transceiver 2230 to receive polarization information for measuring a measurement resource.

As further shown in FIG. 23, the apparatus may include, stored in computer-readable medium 2225, code for receiving the measurement resource (code 2340). For example, the apparatus may include code that, when executed by processor 2220, may cause processor 2220 to cause transceiver 2230 to receive the measurement resource.

As further shown in FIG. 23, the apparatus may include, stored in computer-readable medium 2225, code for performing an L3 measurement of the measurement resource based at least in part on the polarization information (code 2345). For example, the apparatus may include code that, when executed by processor 2220, may cause processor 2220 to cause transceiver 2230 to perform an L3 measurement of the measurement resource based at least in part on the polarization information.

FIG. 23 is provided as an example. Other examples may differ from what is described in connection with FIG. 23.

FIG. 24 is a diagram of an example apparatus 2400 for wireless communication. The apparatus 2400 may be a UE (e.g., a UE 120), or a UE may include the apparatus 2400. In some aspects, the apparatus 2400 includes a reception component 2402 and a transmission component 2404, which may be in communication with one another (for example, via one or more buses and/or one or more other components). As shown, the apparatus 2400 may communicate with another apparatus 2406 (such as a UE, a base station, or another wireless communication device) using the reception component 2402 and the transmission component 2404. As further shown, the apparatus 2400 may include the communication manager 140. The communication manager 140 may include one or more of a calculation component 2408 and/or a measurement component 2410, among other examples.

In some aspects, the apparatus 2400 may be configured to perform one or more operations described herein in connection with FIGS. 1-10. Additionally, or alternatively, the apparatus 2400 may be configured to perform one or more processes described herein, such as process 1400 of FIG. 14. In some aspects, the apparatus 2400 and/or one or more components shown in FIG. 24 may include one or more components of the UE described in connection with FIG. 2. Additionally, or alternatively, one or more components shown in FIG. 24 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2402 may receive communications, such as reference signals, control information, data communications, or a combination thereof, from the apparatus 2406. The reception component 2402 may provide received communications to one or more other components of the apparatus 2400. In some aspects, the reception component 2402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2400. In some aspects, the reception component 2402 may include one or more antennas, a modem, a demodulator, a MIMO detector, a receive processor, a controller/processor, a memory, or a combination thereof, of the UE described in connection with FIG. 2.

The transmission component 2404 may transmit communications, such as reference signals, control information, data communications, or a combination thereof, to the apparatus 2406. In some aspects, one or more other components of the apparatus 2400 may generate communications and may provide the generated communications to the transmission component 2404 for transmission to the apparatus 2406. In some aspects, the transmission component 2404 may perform signal processing on the generated communications (such as filtering, amplification, modulation, digital-to-analog conversion, multiplexing, interleaving, mapping, or encoding, among other examples), and may transmit the processed signals to the apparatus 2406. In some aspects, the transmission component 2404 may include one or more antennas, a modem, a modulator, a transmit MIMO processor, a transmit processor, a controller/processor, a memory, or a combination thereof, of the UE described in connection with FIG. 2. In some aspects, the transmission component 2404 may be co-located with the reception component 2402 in a transceiver.

The calculation component 2408 may calculate a maximum quantity of measurement resources supported by the UE based at least in part on a configured timing for handling a mismatch between a polarization of a measurement resource and a polarization configured at the UE. The reception component 2402 may receive the measurement resource. The measurement component 2410 may perform an L3 measurement of the measurement resource based at least in part on the maximum quantity of measurement resources supported by the UE.

The number and arrangement of components shown in FIG. 24 are provided as an example. In practice, there may be additional components, fewer components, different components, or differently arranged components than those shown in FIG. 24. Furthermore, two or more components shown in FIG. 24 may be implemented within a single component, or a single component shown in FIG. 24 may be implemented as multiple, distributed components. Additionally, or alternatively, a set of (one or more) components shown in FIG. 24 may perform one or more functions described as being performed by another set of components shown in FIG. 24.

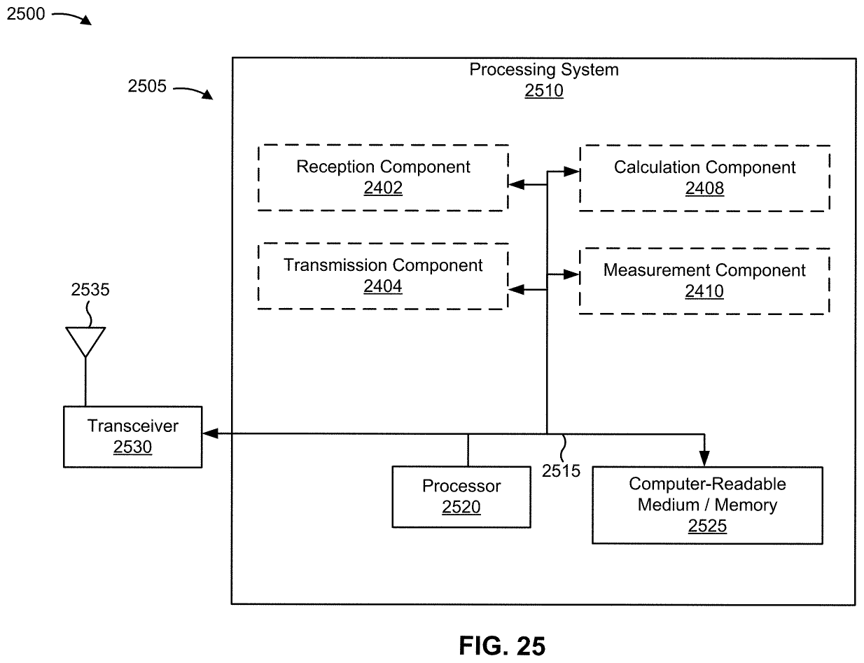

FIG. 25 is a diagram illustrating an example 2500 of a hardware implementation for an apparatus 2505 employing a processing system 2510. The apparatus 2505 may be a UE.

The processing system 2510 may be implemented with a bus architecture, represented generally by the bus 2515. The bus 2515 may include any number of interconnecting buses and bridges depending on the specific application of the processing system 2510 and the overall design constraints. The bus 2515 links together various circuits including one or more processors and/or hardware components, represented by the processor 2520, the illustrated components, and the computer-readable medium/memory 2525. The bus 2515 may also link various other circuits, such as timing sources, peripherals, voltage regulators, and/or power management circuits.

The processing system 2510 may be coupled to a transceiver 2530. The transceiver 2530 is coupled to one or more antennas 2535. The transceiver 2530 provides a means for communicating with various other apparatuses over a transmission medium. The transceiver 2530 receives a signal from the one or more antennas 2535, extracts information from the received signal, and provides the extracted information to the processing system 2510, specifically the reception component 2402. In addition, the transceiver 2530 receives information from the processing system 2510, specifically the transmission component 2404, and generates a signal to be applied to the one or more antennas 2535 based at least in part on the received information.

The processing system 2510 includes a processor 2520 coupled to a computer-readable medium/memory 2525. The processor 2520 is responsible for general processing, including the execution of software stored on the computer-readable medium/memory 2525. The software, when executed by the processor 2520, causes the processing system 2510 to perform the various functions described herein for any particular apparatus. The computer-readable medium/memory 2525 may also be used for storing data that is manipulated by the processor 2520 when executing software. The processing system further includes at least one of the illustrated components. The components may be software modules running in the processor 2520, resident/stored in the computer-readable medium/memory 2525, one or more hardware modules coupled to the processor 2520, or some combination thereof.

In some aspects, the processing system 2510 may be a component of the UE 120 and may include the memory 282 and/or at least one of the TX MIMO processor 266, the RX processor 258, and/or the controller/processor 280. In some aspects, the apparatus 2505 for wireless communication includes means for calculating a maximum quantity of measurement resources supported by the UE based at least in part on a configured timing for handling a mismatch between a polarization of a measurement resource and a polarization configured at the UE; means for receiving the measurement resource; and/or means for performing an L3 measurement of the measurement resource based at least in part on the maximum quantity of measurement resources supported by the UE. The aforementioned means may be one or more of the aforementioned components of the apparatus 2400 and/or the processing system 2510 of the apparatus 2505 configured to perform the functions recited by the aforementioned means. As described elsewhere herein, the processing system 2510 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 25 is provided as an example. Other examples may differ from what is described in connection with FIG. 25.

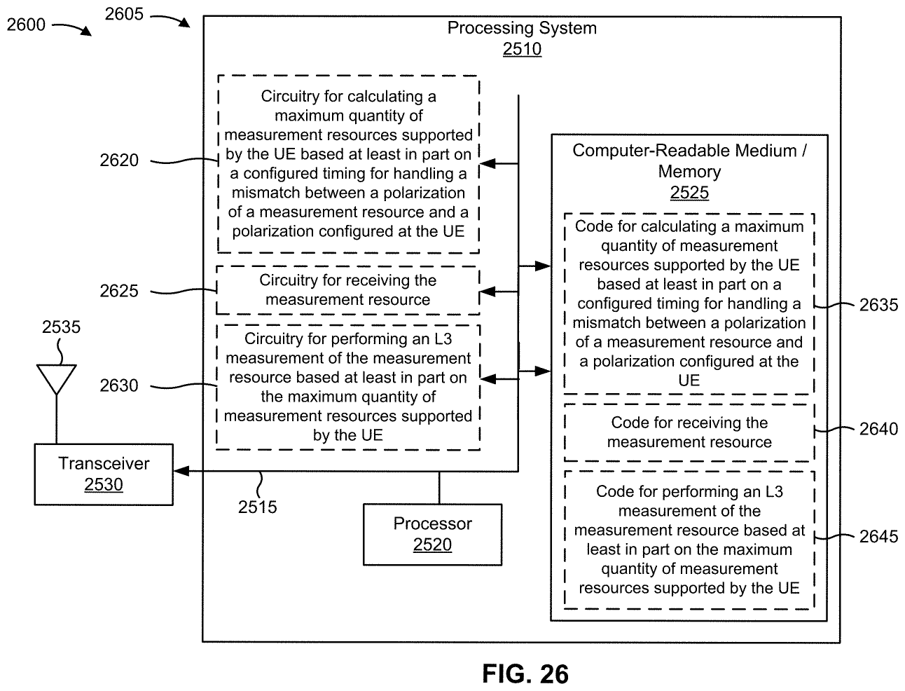

FIG. 26 is a diagram illustrating an example 2600 of an implementation of code and circuitry for an apparatus 2605. Apparatus 2605 may be a UE (e.g., UE 120).

As further shown in FIG. 26, the apparatus may include circuitry for calculating a maximum quantity of measurement resources supported by the UE based at least in part on a configured timing for handling a mismatch between a polarization of a measurement resource and a polarization configured at the UE (circuitry 2620). For example, the apparatus may include circuitry to enable the apparatus to calculate a maximum quantity of measurement resources supported by the UE based at least in part on a configured timing for handling a mismatch between a polarization of a measurement resource and a polarization configured at the UE.

As further shown in FIG. 26, the apparatus may include circuitry for receiving the measurement resource (circuitry 2625). For example, the apparatus may include circuitry to enable the apparatus to receive the measurement resource.

As further shown in FIG. 26, the apparatus may include circuitry for performing an L3 measurement of the measurement resource based at least in part on the maximum quantity of measurement resources supported by the UE (circuitry 2630). For example, the apparatus may include circuitry to enable the apparatus to perform an L3 measurement of the measurement resource based at least in part on the maximum quantity of measurement resources supported by the UE.

As further shown in FIG. 26, the apparatus may include, stored in computer-readable medium 2525, code for calculating a maximum quantity of measurement resources supported by the UE based at least in part on a configured timing for handling a mismatch between a polarization of a measurement resource and a polarization configured at the UE (code 2635). For example, the apparatus may include code that, when executed by the processor 2520, may cause processor 2520 to calculate a maximum quantity of measurement resources supported by the UE based at least in part on a configured timing for handling a mismatch between a polarization of a measurement resource and a polarization configured at the UE.

As further shown in FIG. 26, the apparatus may include, stored in computer-readable medium 2525, code for receiving the measurement resource (code 2640). For example, the apparatus may include code that, when executed by processor 2220, may cause processor 2520 to cause transceiver 2530 to receive the measurement resource.

As further shown in FIG. 26, the apparatus may include, stored in computer-readable medium 2525, code for performing an L3 measurement of the measurement resource based at least in part on the maximum quantity of measurement resources supported by the UE (code 2645). For example, the apparatus may include code that, when executed by processor 2520, may cause processor 2520 to cause transceiver 2530 to perform an L3 measurement of the measurement resource based at least in part on the maximum quantity of measurement resources supported by the UE.

FIG. 26 is provided as an example. Other examples may differ from what is described in connection with FIG. 26.

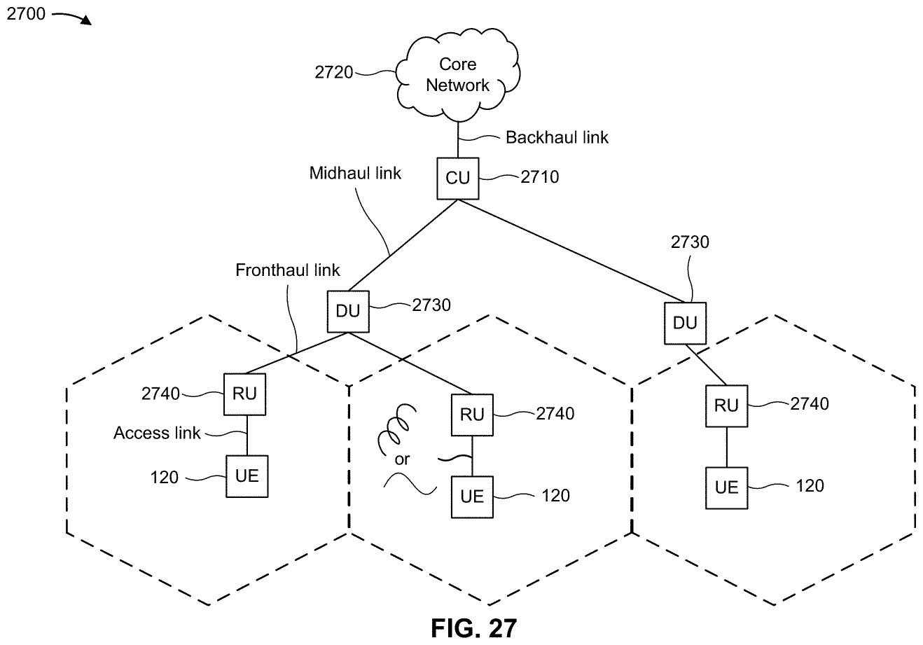

FIG. 27 is a diagram illustrating an example 2700 of an open radio access network (O-RAN) architecture, in accordance with the present disclosure. As shown in FIG. 27, the O-RAN architecture may include a central unit (CU) 2710 that communicates with a core network 2720 via a backhaul link. Furthermore, the CU 2710 may communicate with one or more distributed units (DUs) 2730 via respective midhaul links. The DUs 2730 may each communicate with one or more radio units (RUs) 2740 via respective fronthaul links, and the RUs 2740 may each communicate with respective UEs 120 via radio frequency (RF) access links. The DUs 2730 and the RUs 2740 may also be referred to as O-RAN DUs (O-DUs) 2730 and O-RAN RUs (O-RUs) 2740, respectively.

In some aspects, the DUs 2730 and the RUs 2740 may be implemented according to a functional split architecture in which functionality of a base station 110 (e.g., an eNB or a gNB) is provided by a DU 2730 and one or more RUs 2740 that communicate over a fronthaul link. Accordingly, as described herein, a base station 110 may include a DU 2730 and one or more RUs 2740 that may be co-located or geographically distributed. In some aspects, the DU 2730 and the associated RU(s) 2740 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 2730 may correspond to a logical unit that includes one or more base station functions to control the operation of one or more RUs 2740. For example, in some aspects, the DU 2730 may host an RLC layer, a MAC layer, and one or more high PHY layers (e.g., forward error correction (FEC) encoding and decoding, scrambling, and/or modulation and demodulation) based at least in part on a lower layer functional split. Higher layer control functions, such as a PDCP, RRC, and/or SDAP, may be hosted by the CU 2710. The RU(s) 2740 controlled by a DU 2730 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 2740 handle all over the air (OTA) communication with a UE 120, and real-time and non-real-time aspects of control and user plane communication with the RU(s) 2740 are controlled by the corresponding DU 2730, which enables the DU(s) 2730 and the CU 2710 to be implemented in a cloud-based RAN architecture.

In some aspects, a UE 120 may receive a measurement resource from an RU 2740, which received a configuration for the measurement resource from DU 2730. The UE 120 may perform an L3 measurement of the measurement resource using a first polarization that is dedicated for performing L3 measurements and that is supported by the UE. In some aspects, the UE 120 may receive polarization information from the RU 2740. UE 120 may transmit a measurement report to the RU 2740, which may forward the measurement report to the DU 2730. The RU 2740, the DU 2730, and/or the CU 2710 may use the measurement report to configure and/or schedule measurement resources or other communications.

As indicated above, FIG. 27 is provided as an example. Other examples may differ from what is described with regard to FIG. 27.

The following provides an overview of some Aspects of the present disclosure:

Aspect 1: A method of wireless communication performed by a user equipment (UE), comprising: receiving a measurement resource; and performing a Layer 3 (L3) measurement of the measurement resource using a first polarization that is dedicated for performing L3 measurements and that is supported by the UE.

Aspect 2: The method of Aspect 1, wherein performing the L3 measurement of the measurement resource includes performing the L3 measurement of the measurement resource based at least in part on a UE capability of using the first polarization for performing L3 measurements on the measurement resource.

Aspect 3: The method of Aspect 1 or 2, further comprising receiving an indication of the first polarization.

Aspect 4: A method of wireless communication performed by a user equipment (UE), comprising: receiving a measurement resource; performing a Layer 3 (L3) measurement of the measurement resource independent of a requirement for the UE to use a first polarization that is dedicated for performing L3 measurements, in response to the UE supporting use of the first polarization for L3 measurements; and performing the L3 measurement of the measurement resource using a polarization of a most recent serving cell downlink communication in response to the UE not supporting use of the first polarization for L3 measurements.

Aspect 5: The method of Aspect 4, wherein performing the L3 measurement using the polarization of the most recent serving cell downlink communication includes performing the L3 measurement in response to a polarization of the measurement resource and a polarization configured at the UE being the same.

Aspect 6: The method of Aspect 4, wherein performing the L3 measurement using the polarization of the most recent serving cell downlink communication includes performing the L3 measurement in response to a mismatch between a polarization of the measurement resource and a polarization configured at the UE being a linear polarization mismatch.

Aspect 7: The method of Aspect 6, further comprising: stopping measuring interference; and stopping filtering of L3 measurements.

Aspect 8: The method of Aspect 4, wherein performing the L3 measurement using the polarization of the most recent serving cell downlink communication includes performing the L3 measurement in response to a mismatch between a polarization of the measurement resource and a polarization configured at the UE being a circular polarization mismatch.

Aspect 9: The method of Aspect 8, further comprising: stopping measuring interference; and stopping filtering of L3 measurements.

Aspect 10: The method of Aspect 4, wherein performing the L3 measurement using the polarization of the most recent serving cell downlink communication includes performing the L3 measurement based at least in part on a capability of the UE to handle a polarization mismatch.

Aspect 11: The method of Aspect 4, wherein performing the L3 measurement using the polarization of the most recent serving cell downlink communication includes performing the L3 measurement based at least in part on a UE behavior for handling mismatches that is indicated by stored configuration information.

Aspect 12: The method of any of Aspects 4-11, further comprising compensating for a polarization mismatch before filtering the L3 measurement.

Aspect 13: The method of Aspect 12, wherein compensating for the polarization mismatch includes adding a specified gain value to the L3 measurement.

Aspect 14: The method of Aspect 13, wherein the specified gain value is a value between 2.9 decibels (dB) and 3.1 dB.

Aspect 15: A method of wireless communication performed by a user equipment (UE), comprising: receiving polarization information for measuring a measurement resource; receiving the measurement resource; and performing a Layer 3 (L3) measurement of the measurement resource based at least in part on the polarization information.

Aspect 16: The method of Aspect 15, wherein receiving the polarization information includes receiving the polarization information in a polarization configuration field in a measurement resource configuration.

Aspect 17: The method of Aspect 15 or 16, wherein receiving the polarization information includes receiving an identifier of a measurement target in response to a polarization configured at the UE being configured for the measurement target.

Aspect 18: A method of wireless communication performed by a user equipment (UE), comprising: calculating a maximum quantity of measurement resources supported by the UE based at least in part on a configured timing for handling a mismatch between a polarization of a measurement resource and a polarization configured at the UE; receiving the measurement resource; and performing a Layer 3 (L3) measurement of the measurement resource based at least in part on the maximum quantity of measurement resources supported by the UE.

Aspect 19: The method of Aspect 18, wherein calculating the maximum quantity of measurement resources supported by the UE based at least in part on the configured timing includes calculating the maximum quantity of measurement resources supported by the UE after handling the mismatch.

Aspect 20: The method of Aspect 18, wherein calculating the maximum quantity of measurement resources supported by the UE based at least in part on the configured timing includes calculating the maximum quantity of measurement resources supported by the UE before handling the mismatch.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory, the memory and the one or more processors configured to:
receive a measurement resource; and
perform a Layer 3 (L3) measurement of the measurement resource using a first polarization that is dedicated for performing L3 measurements and that is supported by the UE.

2. The UE of claim 1, wherein the memory and the one or more processors, to perform the L3 measurement of the measurement resource, are configured to perform the L3 measurement of the measurement resource based at least in part on a UE capability of using the first polarization for performing L3 measurements on the measurement resource.

3. The UE of claim 1, wherein the memory and the one or more processors are configured to receive an indication of the first polarization.

4. A user equipment (UE) for wireless communication, comprising:
a memory; and
one or more processors coupled to the memory, the memory and the one or more processors configured to:
receive a measurement resource;
perform a Layer 3 (L3) measurement of the measurement resource independent of a requirement for the UE to use a first polarization that is dedicated for performing L3 measurements, in response to the UE supporting use of the first polarization for L3 measurements; and
perform the L3 measurement of the measurement resource using a polarization of a most recent serving cell downlink communication in response to the UE not supporting use of the first polarization for L3 measurements.

5. The UE of claim 4, wherein the memory and the one or more processors, to perform the L3 measurement using the polarization of the most recent serving cell downlink communication, are configured to perform the L3 measurement in response to a polarization of the measurement resource and a polarization configured at the UE being the same.

6. The UE of claim 4, wherein the memory and the one or more processors, to perform the L3 measurement using the polarization of the most recent serving cell downlink communication, are configured to perform the L3 measurement in response to a mismatch between a polarization of the measurement resource and a polarization configured at the UE being a linear polarization mismatch.

7. The UE of claim 6, wherein the memory and the one or more processors are configured to:
stop measuring interference; and
stop filtering of L3 measurements.

8. The UE of claim 4, wherein the memory and the one or more processors, to perform the L3 measurement using the polarization of the most recent serving cell downlink communication, are configured to perform the L3 measurement in response to a mismatch between a polarization of the measurement resource and a polarization configured at the UE being a circular polarization mismatch.

9. The UE of claim 8, wherein the memory and the one or more processors are configured to:
stop measuring interference; and
stop filtering of L3 measurements.

10. The UE of claim 4, wherein the memory and the one or more processors, to perform the L3 measurement using the polarization of the most recent serving cell downlink communication, are configured to perform the L3 measurement based at least in part on a capability of the UE to handle a polarization mismatch.

11. The UE of claim 4, wherein the memory and the one or more processors, to perform the L3 measurement using the polarization of the most recent serving cell downlink communication, are configured to perform the L3 measurement based at least in part on a UE behavior for handling mismatches that is indicated by stored configuration information.

12. The UE of claim 4, wherein the memory and the one or more processors are configured to compensate for a polarization mismatch before filtering the L3 measurement.

13. The UE of claim 12, wherein the memory and the one or more processors, to compensate for the polarization mismatch, are configured to add a specified gain value to the L3 measurement.

14. The UE of claim 13, wherein the specified gain value includes a value between 2.9 decibels (dB) and 3.1 dB.

15. A user equipment (UE) for wireless communication, comprising:
a memory; and
one or more processors coupled to the memory, the memory and the one or more processors configured to:
receive polarization information for measuring a measurement resource;
receive the measurement resource; and
perform a Layer 3 (L3) measurement of the measurement resource based at least in part on the polarization information.

16. The UE of claim 15, wherein the memory and the one or more processors, to receive the polarization information, are configured to receive the polarization information in a polarization configuration field in a measurement resource configuration.

17. The UE of claim 15, wherein the memory and the one or more processors, to receive the polarization information, are configured to receive an identifier of a measurement target in response to a polarization configured at the UE being configured for the measurement target.

18. A user equipment (UE) for wireless communication, comprising:
a memory; and
one or more processors coupled to the memory, the memory and the one or more processors configured to:
calculate a maximum quantity of measurement resources supported by the UE based at least in part on a configured timing for handling a mismatch between a polarization of a measurement resource and a polarization configured at the UE;
receive the measurement resource; and
perform a Layer 3 (L3) measurement of the measurement resource based at least in part on the maximum quantity of measurement resources supported by the UE.

19. The UE of claim 18, wherein the memory and the one or more processors, to calculate the maximum quantity of measurement resources supported by the UE based at least in part on the configured timing, are configured to calculate the maximum quantity of measurement resources supported by the UE after handling the mismatch.

20. The UE of claim 18, wherein the memory and the one or more processors, to calculate the maximum quantity of measurement resources supported by the UE based at least in part on the configured timing, are configured to calculate the maximum quantity of measurement resources supported by the UE before handling the mismatch.
